(19) United States
(12) Patent Application Publication
(10) Pub. No.: US 2024/0149878 A1
(43) Pub. Date: May 9, 2024

(54) VEHICLE CONTROL APPARATUS AND VEHICLE CONTROL METHOD

(71) Applicant: Mitsubishi Electric Corporation, Tokyo (JP)

(72) Inventors: Yuko OMAGARI, Tokyo (JP); Yuki YOSHIDA, Tokyo (JP); Mizuho WAKABAYASHI, Tokyo (JP); Kenta TOMINAGA, Tokyo (JP)

(73) Assignee: Mitsubishi Electric Corporation, Tokyo (JP)

(21) Appl. No.: 18/488,344

(22) Filed: Oct. 17, 2023

(30) Foreign Application Priority Data
Nov. 7, 2022 (JP) 2022-177841

(51) Int. Cl. B60W 30/18; B60W 10/20; B60W 40/04; B60W 40/06; B60W 40/105; B60W 40/109; B60W 60/00

(52) U.S. Cl. CPC B60W 30/18163; B60W 10/20; B60W 40/04; B60W 40/06; B60W 40/105; B60W 40/109; B60W 60/0015; B60W 60/0053; B60W 2520/125; B60W 2554/4041; B60W 2554/406; B60W 2555/60

(57) ABSTRACT

To provide a vehicle control apparatus and a vehicle control method which can determine whether or not an ego vehicle can merge into a main lane from a merging lane based on an estimated behavior of the ego vehicle on the merging lane. A vehicle control apparatus determines whether or not an estimated speed of an ego vehicle reaches a target speed; determines whether or not the ego vehicle can stop emergently, based on whether or not a distance from a merging start possible position to an end of the merging lane is greater than or equal to an emergency stop necessary distance; determines whether or not the ego vehicle can merge, based on the determination result of the target speed reaching propriety, and the determination result of the emergency stop propriety, and controls a driving of the ego vehicle, based on a determination result of merging propriety.

### INCORPORATION BY REFERENCE

The disclosure of Japanese Patent Application No. 2022-177841 filed on Nov. 7, 2022 including its specification, claims and drawings, is incorporated herein by reference in its entirety.

### BACKGROUND

The present disclosure relates to a vehicle control apparatus and a vehicle control method.

Previously, in a merging lane of highway, a vehicle control apparatus which controls steering, and acceleration or deceleration of an ego vehicle to merge into a main lane from the merging lane is known.

For example, in the technology of JP 5434336 B, the vehicle control apparatus sets speed threshold values for a plurality of regions on the merging lane, compares the speed of the ego vehicle with the speed threshold values, and determines the merging propriety.

### SUMMARY

However, in the technology of JP 5434336 B, after the ego vehicle arrives at a merging start possible position, the vehicle control apparatus compares the actual detection speed of the ego vehicle with the speed threshold value of each region, and determines whether or not the ego vehicle can merge. Accordingly, before arriving at the merging start possible position, the vehicle control apparatus cannot determine by estimating the future. And, when determining that the merging is impossible, it is necessary to quickly perform a vehicle control for merging impossible from a position which passed the merging start possible position, and a safeness of driver is deteriorated.

Then, the purpose of the present disclosure is to provide a vehicle control apparatus and a vehicle control method which can estimate the behavior of the ego vehicle on the merging lane, and can determine whether or not the ego vehicle can merge into the main lane from the merging lane based on the prediction result.

A vehicle control apparatus according to the present disclosure including:
a target speed reaching determination unit that estimates a speed of an ego vehicle on a merging lane, based on road information in front of the ego vehicle which travels on the merging lane which merges into a main lane, and determines whether or not the estimated speed of the ego vehicle reaches a target speed for merging into the main lane;
an emergency stop propriety determination unit that determines whether or not the ego vehicle can stop emergently on the merging lane, based on whether or not a distance from a merging start possible position where a start of the merging into the main lane becomes possible on the merging lane, to an end of the merging lane is greater than or equal to an emergency stop necessary distance required for stopping the ego vehicle emergently;
a merging propriety determination unit that determines whether or not the ego vehicle can merge into the main lane from the merging lane, based on a determination result of a target speed reaching propriety by the target speed reaching determination unit, and a determination result of an emergency stop propriety by the emergency stop propriety determination unit; and
a vehicle control unit that controls a driving of the ego vehicle, based on a determination result of a merging propriety by the merging propriety determination unit.

A vehicle control method according to the present disclosure including:
a target speed reaching determination step of estimating a speed of an ego vehicle on a merging lane, based on road information in front of the ego vehicle which travels on the merging lane which merges into a main lane, and determining whether or not the estimated speed of the ego vehicle reaches a target speed for merging into the main lane;
an emergency stop propriety determination step of determining whether or not the ego vehicle can stop emergently on the merging lane, based on whether or not a distance from a merging start possible position where a start of the merging into the main lane becomes possible on the merging lane to an end of the merging lane is greater than or equal to an emergency stop necessary distance required for stopping the ego vehicle emergently;
a merging propriety determination step of determining whether or not the ego vehicle can merge into the main lane from the merging lane, based on a determination result of a target speed reaching propriety by the target speed reaching determination step, and a determination result of an emergency stop propriety by the emergency stop propriety determination step; and
a vehicle control step of controlling a driving of the ego vehicle, based on a determination result of a merging propriety by the merging propriety determination step.

According to the vehicle control apparatus and the vehicle control method of the present disclosure, the speed of the ego vehicle on the merging lane is estimated based on the road information in front of the ego vehicle which travels on the merging lane, and it is determined whether or not the estimated speed of the ego vehicle reaches the target speed for merging into the main lane. And, it is determined whether or not the ego vehicle can stop emergently on the merging lane, based on whether or not the distance from the merging start possible position to the end of the merging lane is greater than or equal to the emergency stop necessary distance required for stopping the ego vehicle emergently. Then, it is determined whether or not the ego vehicle can merge into the main lane from the merging lane based on the determination result of the target speed reaching propriety, and the determination result of the emergency stop propriety, the driving of the ego vehicle is controlled based on the determination result of merging propriety. Accordingly, the behavior of the ego vehicle on the merging lane is estimated, the merging propriety is determined based on the prediction result, and the vehicle control is performed. Accordingly, since the determination is performed by estimating the future and the vehicle control is performed, the safety at the time of merging and the safeness of driver are obtained. Although it is better to sufficiently accelerate until the merging start possible position in order to be able to reach the target speed, it is better not to accelerate too much until the merging start possible position in order to be able to stop emergently. That is, being able to reach the target speed and being able to stop emergently are in a trade-off relation. Accordingly, by determining whether or not the merging vehicle can merge based on the determination result of the target speed reaching propriety, and the determination result of the emergency stop propriety, it can be determined considering both determination results which are in the trade-off relation, and the safety at the time of merging can be improved.

### BRIEF DESCRIPTION OF THE DRAWINGS

FIG. 1 is a schematic block diagram of the vehicle control apparatus according to Embodiment 1;

FIG. 2 is a schematic hardware configuration diagram of the vehicle control apparatus according to Embodiment 1;

FIG. 3 is a flowchart for explaining schematic processing of the vehicle control apparatus according to Embodiment 1;

FIG. 4 is a figure for explaining the ego vehicle coordinate system according to Embodiment 1;

FIG. 5 is a figure for explaining the merging lane, the main lane, and the like according to Embodiment 1;

FIG. 6 is a flowchart for explaining the correction processing of the limit speed by road shape according to Embodiment 1;

FIG. 7 is a figure for explaining the limitation processing of the composite acceleration according to Embodiment 1;

FIG. 8 is a figure for explaining the estimation processing of the estimated speed according to Embodiment 1;

FIG. 9 is a figure for explaining the calculation of the emergency stop necessary distance according to Embodiment 1;

FIG. 10 is a flowchart for explaining the determination processing of the merging propriety according to Embodiment 1;

FIG. 11 is a flowchart for explaining the processing of the vehicle control unit according to Embodiment 1;

FIG. 12 is a flowchart for explaining the processing of the vehicle control unit according to Embodiment 2;

FIG. 13 is a schematic block diagram of the vehicle control apparatus according to Embodiment 3;

FIG. 14 is a figure for explaining the determination of presence or absence of congestion of the main lane according to Embodiment 3;

FIG. 15 is a flowchart for explaining the processing of the main lane congestion determination unit and the merging propriety determination unit according to Embodiment 3;

FIG. 16 is a schematic block diagram of the vehicle control apparatus according to Embodiment 4;

FIG. 17 is a flowchart for explaining the processing of the low-speed vehicle determination unit and the merging propriety determination unit according to Embodiment 4;

FIG. 18 is a schematic block diagram of the vehicle control apparatus according to Embodiment 5; and

FIG. 19 is a flowchart for explaining the processing of the steering control determination unit and the merging propriety determination unit according to Embodiment 5.

### DETAILED DESCRIPTION OF THE EMBODIMENTS

### 1. Embodiment 1

The vehicle control apparatus 50 according to Embodiment 1 will be explained with reference to drawings. In the present embodiment, the vehicle control apparatus 50 is provided in the ego vehicle.

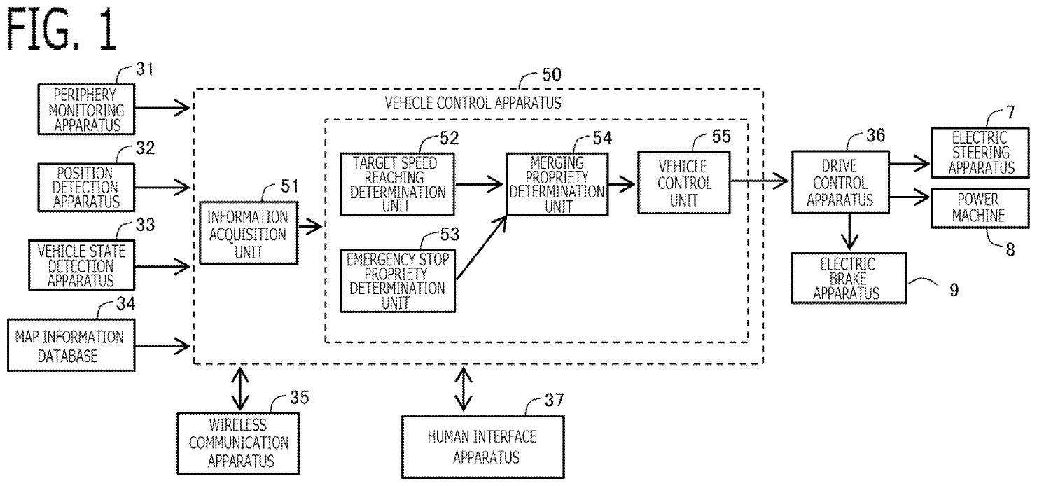

As shown in FIG. 1, the ego vehicle is provided with a periphery monitoring apparatus 31, a position detection apparatus 32, a vehicle state detection apparatus 33, a map information database 34, a wireless communication apparatus 35, a vehicle control apparatus 50, a drive control apparatus 36, a power machine 8, an electric steering apparatus 7, an electric brake apparatus 9, a human interface apparatus 37, and the like.

The periphery monitoring apparatus 31 is an apparatus which monitors the periphery of vehicle, such as a camera and a radar. As the radar, a millimeter wave radar, a laser radar, an ultrasonic radar, and the like are used. The wireless communication apparatus 35 performs a wireless communication with a base station, using the wireless communication standard of cellular communication system, such as 4G and 5G.

The position detection apparatus 32 is an apparatus which detects the current position (latitude, longitude, altitude) of the ego vehicle, and a GPS antenna which receives the signal outputted from satellites, such as GNSS (Global Navigation Satellite System), is used. For detection of the current position of the ego vehicle, various kinds of methods, such as the method using the traveling lane identification number of the ego vehicle, the map matching method, the dead reckoning method, and the method using the detection information around the ego vehicle, may be used.

In the map information database 34, road information, such as a road shape (for example, a lane number, a position of each lane, a shape of each lane, a type of each lane, a road type, a limit speed, and the like), a sign, and a road signal, is stored. The details will be described later. The map information database 34 is mainly constituted of a storage apparatus. The map information database 34 may be provided in a server outside the vehicle connected to the network, and the vehicle control apparatus 50 may acquire required road information from the server outside the vehicle via the wireless communication apparatus 35.

As the drive control apparatus 36, a power controller, a brake controller, an automatic steering controller, a light controller, and the like are provided. The power controller controls output of a power machine 8, such as an internal combustion engine and a motor. The brake controller controls brake operation of the electric brake apparatus 9. The automatic steering controller controls the electric steering apparatus 7. The light controller controls a direction indicator, a hazard lamp, and the like.

The vehicle state detection apparatus 33 is a detection apparatus which detects an ego vehicle state which is a driving state and a traveling state of the ego vehicle. In the present embodiment, the vehicle state detection apparatus 33 detects a speed, an acceleration, a yaw rate, a steering angle, a lateral acceleration and the like of the ego vehicle, as the traveling state of the ego vehicle. For example, as the vehicle state detection apparatus 33, a speed sensor which detects a rotational speed of wheels, an acceleration sensor, an angular speed sensor, a steering angle sensor, and the like are provided.

As the driving state of the ego vehicle, an acceleration or deceleration operation, a steering angle operation, and a lane change operation by a driver are detected. For example, as the vehicle state detection apparatus 33, an accelerator position sensor, a brake position sensor, a steering angle sensor (handle angle sensor), a steering torque sensor, a direction indicator position switch, and the like are provided.

The human interface apparatus 37 is an apparatus which receives input of the driver or transmits information to the driver, such as a loudspeaker, a display screen, an input device, and the like.

### 1-1. Vehicle Control Apparatus 50

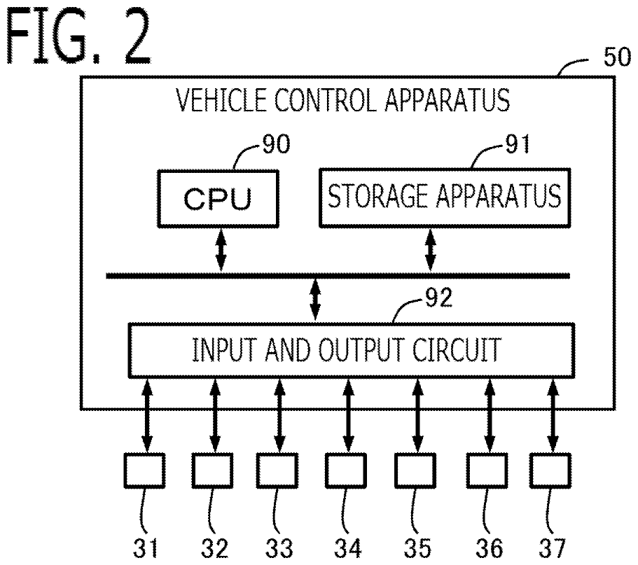

The vehicle control apparatus 50 is provided with processing units such as an information acquisition unit 51, a target speed reaching determination unit 52, an emergency stop propriety determination unit 53, a merging propriety determination unit 54, and a vehicle control unit 55. Each processing of the vehicle control apparatus 50 is realized by processing circuits provided in the vehicle control apparatus 50. As shown in FIG. 2, specifically, the vehicle control apparatus 50 is provided with an arithmetic processor 90 such as CPU (Central Processing Unit), storage apparatuses 91, an input and output circuit 92 which outputs and inputs external signals to the arithmetic processor 90, and the like.

As the arithmetic processor 90, ASIC (Application Specific Integrated Circuit), IC (Integrated Circuit), DSP (Digital Signal Processor), FPGA (Field Programmable Gate Array), GPU (Graphics Processing Unit), AI (Artificial Intelligence) chip, various kinds of logical circuits, various kinds of signal processing circuits, and the like may be provided. As the arithmetic processor 90, a plurality of the same type ones or the different type ones may be provided, and each processing may be shared and executed. As the storage apparatuses 91, various kinds of storage apparatuses, such as RAM (Random Access Memory), ROM (Read Only Memory), a flash memory, EEPROM (Electrically Erasable Programmable Read Only Memory), and a hard disk, are used.

The input and output circuit 92 is provided with a communication device, an A/D converter, an input/output port, a driving circuit, and the like. The input and output circuit 92 is connected to the periphery monitoring apparatus 31, the position detection apparatus 32, the vehicle state detection apparatus 33, the map information database 34, the wireless communication apparatus 35, the drive control apparatus 36, and the human interface apparatus 37, and communicates with these devices.

Then, the arithmetic processor 90 runs software items (programs) stored in the storage apparatus 91 and collaborates with other hardware devices in the vehicle control apparatus 50, such as the storage apparatus 91, and the input and output circuit 92, so that the respective processings of the processing units 51 to 55 provided in the vehicle control apparatus 50 are realized. Setting data items, such as the maximum lateral acceleration aymax, the maximum longitudinal acceleration axmax, the inquiry waiting time Twt, and the threshold value, to be utilized in the processing units 51 to 55 are stored in the storage apparatus 91, such as EEPROM.

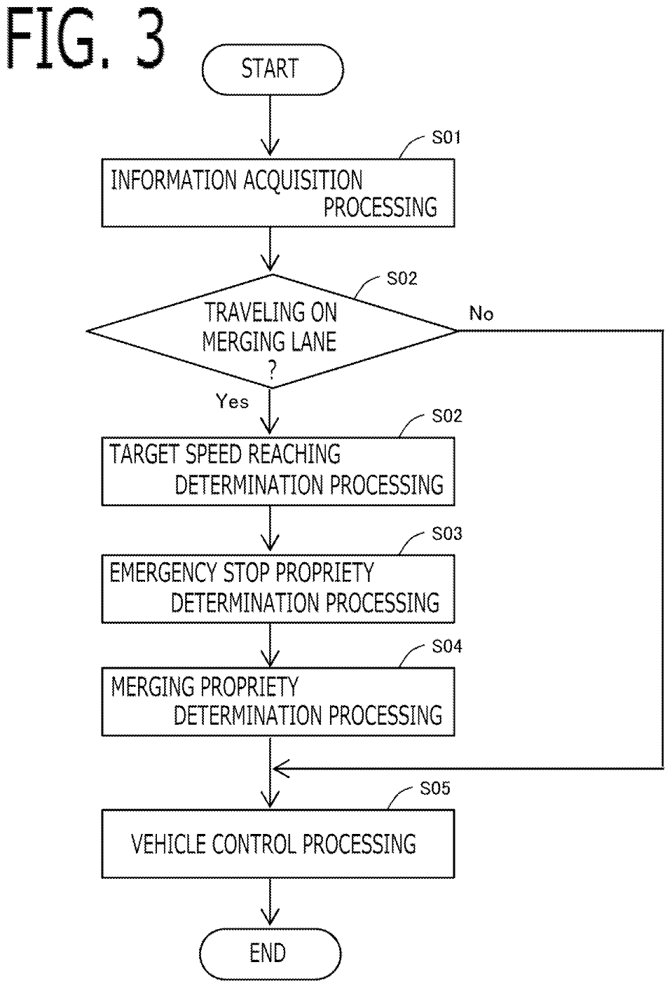

Hereinafter, each processing of the vehicle control apparatus 50 will be explained in detail, referring to the flowchart of FIG. 3. Processing of the flowchart of FIG. 3 is executed at every predetermined calculation period, for example.

### 1-1-1. Information Acquisition Unit 51

In the step S01 of FIG. 3, the information acquisition unit 51 acquires movement information of the ego vehicle and the peripheral vehicle, and road information around the ego vehicle.

The information acquisition unit 51 acquires movement information of the ego vehicle. In the present embodiment, the information acquisition unit 51 acquires a position, a moving direction, a speed, an acceleration, and the like of the ego vehicle, based on position information of the ego vehicle acquired from the position detection apparatus 32, and the ego vehicle state acquired from the vehicle state detection apparatus 33.

The information acquisition unit 51 acquires movement information of the peripheral vehicle which exists around the ego vehicle. In the present embodiment, the information acquisition unit 51 acquires a position, a moving direction, a speed, an acceleration, and the like of the peripheral vehicle, based on detection information acquired from the periphery monitoring apparatus 31, and position information of the ego vehicle acquired from the position detection apparatus 32. The information acquisition unit 51 also acquires information of an obstacle, a pedestrian, a sign, a traffic regulation such as lane regulation, and the like, other than the peripheral vehicle.

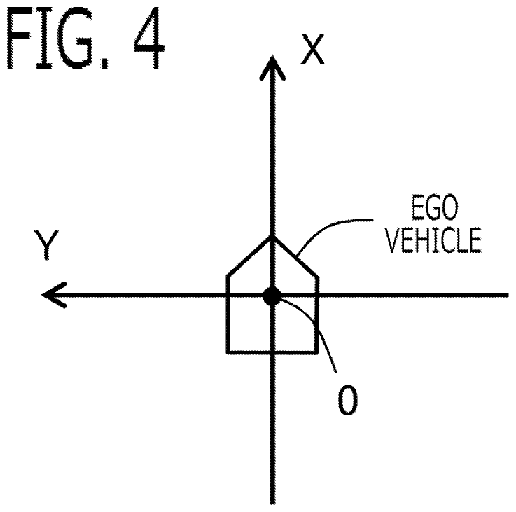

In the present embodiment, the information acquisition unit 51 acquires a relative position and a relative speed of the peripheral vehicle and the like with respect to the ego vehicle in an ego vehicle coordinate system on the basis of the current position of the ego vehicle. As shown in FIG. 4, the ego vehicle coordinate system is a coordinate system which has two axes of a longitudinal direction X and a lateral direction Y of the present ego vehicle. The information acquisition unit 51 may acquire the relative position and the relative speed of the peripheral vehicle in a coordinate system of a longitudinal direction and a lateral direction of the ego lane where the ego vehicle is traveling. The information acquisition unit 51 may acquire an absolute position (latitude, longitude), an absolute moving direction (azimuth), an absolute speed, an absolute acceleration, and the like of each vehicle.

The information acquisition unit 51 acquires road information around the ego vehicle from the map information database 34, based on the position information of the ego vehicle acquired from the position detection apparatus 32. The acquired road information includes the lane number, the position of each lane, the shape of each lane, the type of each lane, the road type, the limit speed, and the like. The shape of each lane includes a position of lane, a curvature of lane, a longitudinal slope of lane, a cross slope of lane, a width of lane, and the like. The shape of lane is set at each point along the longitudinal direction of the lane. The type of each lane includes a merging lane, a main lane into which the merging lane merges, and the like. The shape of lane includes a merging start possible position where a start of the merging into the main lane becomes possible on the merging lane, and an end position of the merging lane. The information acquisition unit 51 acquires information of traffic regulation, such as a lane regulation due to construction, from the external server and the like.

The information acquisition unit 51 detects a shape and a type of a lane marking and the like of the road, based on the detection information on the lane marking, such as a white line and a road shoulder, acquired from the periphery monitoring apparatus 31; and determines the shape and the position of each lane, the lane number, the type of each lane, and the like, based on the detected shape and the detected type of the lane marking of the road. The shape of each lane includes the position of lane, the curvature of lane, the longitudinal slope of lane, the cross slope of lane, the width of lane, and the like. The type of each lane includes the merging lane, the main lane, and the like. The shape of lane includes the merging start possible position and the end position of the merging lane. The information acquisition unit 51 also determines a presence or absence of the traffic regulation, such as the lane regulation.

The information acquisition unit 51 may acquire the movement information of the peripheral vehicle (the position, the moving direction, the speed, and the like of the peripheral vehicle), and the road information (the lane information and the like) and the traffic information (an obstacle, a congestion degree, and the like) around the ego vehicle, from the outside of the ego vehicle by communication. For example, the information acquisition unit 51 may acquire the movement information of the peripheral vehicle, and the road information and the traffic information around the ego vehicle, from the peripheral vehicle or the server to which the peripheral vehicle uploaded information, by the wireless communication and the like. The information acquisition unit 51 may acquire the movement information of the peripheral vehicle, the road information, the traffic information, and the like in a monitor area, from a roadside machine, such as a camera, which monitors the condition of the road, and the like, by the wireless communication and the like.

The information acquisition unit 51 acquires the lane information corresponding to a lane where the ego vehicle is traveling, based on the position of the ego vehicle. The information acquisition unit 51 acquires the lane information corresponding to a lane where each peripheral vehicle is traveling, based on the position of each peripheral vehicle. The acquired lane information includes the shape, the position, and the type of the lane, and the lane information of the peripheral lane.

### 1-1-2. Target Speed Reaching Determination Unit 52

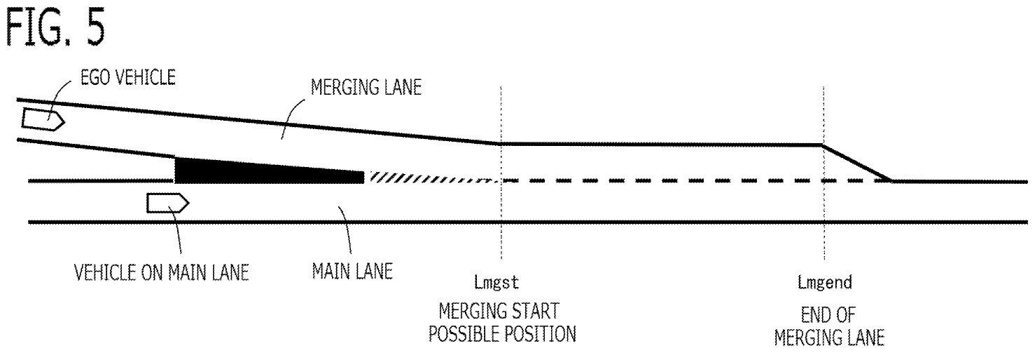

In the step S02 of FIG. 3, the target speed reaching determination unit 52 determines whether or not the ego vehicle is traveling on the merging lane. When traveling on the merging lane, it advances to the step S03, and when not traveling on the merging lane, it advances to the step S05. The target speed reaching determination unit 52 determines that the ego vehicle is traveling on the merging lane, when the lane information of the ego vehicle acquired by the information acquisition unit 51 is the merging lane. As shown in FIG. 5, the merging lane also includes a connecting lane, such as a lamp, which reaches at the merging start possible position Lmgst. The target speed reaching determination unit 52 determines the main lane into which the merging lane merges, from the lanes around the ego vehicle acquired by the information acquisition unit 51. The target speed reaching determination unit 52 acquires the lane information of the merging lane, the movement information of the peripheral vehicle which is traveling on the merging lane, the lane information of the main lane, and the movement information of the peripheral vehicle which is traveling on the main lane, from the information acquisition unit 51.

In the step S03, the target speed reaching determination unit 52 estimates a speed Vpre of the ego vehicle on the merging lane, based on road information in front of the ego vehicle which travels on the merging lane which merges into the main lane, and determines whether or not the estimated speed Vpre of the ego vehicle reaches a target speed Vobj for merging into the main lane.

### <Setting of Target Speed Vobj>

In the present embodiment, the target speed reaching determination unit 52 sets the target speed Vobj, based on a limit speed Vlmt of the main lane. For example, as shown in the next equation, the target speed Vobj is set by multiplying a coefficient (in this example, 0.8) smaller than 1, to the limit speed Vlmt of the main lane. The limit speed Vlmt of the main lane is the limit speed of the main lane acquired by the information acquisition unit 51, and is normally a legal limit speed. According to this configuration, the target speed Vobj which does not disturb a traveling of a main lane vehicle which is traveling according to the limit speed Vlmt of the main lane can be set.

[Math. 1]

V_{obj}=0.8×Vₗₘₜ (1)

### <Speed Estimation Considering Road Shape and Maximum Lateral Acceleration>

The target speed reaching determination unit 52 estimates the estimated speed Vpre of the ego vehicle on the merging lane, based on the road shape of the merging lane, and a maximum lateral acceleration aymax which is allowable for the ego vehicle. A speed which can be realized by the ego vehicle changes according to the road shape and the maximum lateral acceleration aymax. According to this configuration, the estimated speed Vpre which can be realized by the ego vehicle is estimated based on the road shape and the maximum lateral acceleration aymax, and determination accuracy can be improved.

### <Calculation of Limit Speed by Road Shape VlmtR>

In the present embodiment, the target speed reaching determination unit 52 calculates a limit speed by road shape VlmtR which is a speed at which a lateral acceleration ay of the ego vehicle becomes less than or equal to the maximum lateral acceleration aymax, based on the road shape of the merging lane and the maximum lateral acceleration aymax; and estimates the estimated speed Vpre of the ego vehicle on the merging lane so that the estimated speed of the ego vehicle becomes less than or equal to the limit speed by road shape VlmtR. According to this configuration, the estimated speed Vpre such that the lateral acceleration ay of the ego vehicle becomes less than or equal to the maximum lateral acceleration aymax can be estimated with good accuracy.

A curvature ρ is used as the road shape of the merging lane. The target speed reaching determination unit 52 calculates the limit speed by road shape VlmtR (L0) at each estimation position L0, based on the curvature ρ (L0) of the road at each estimation position L0 of the merging lane in front of the ego vehicle, and the maximum lateral acceleration aymax. For example, using the next equation, the target speed reaching determination unit 52 calculates the limit speed by road shape VlmtR (L0). Herein, the maximum lateral acceleration aymax is preliminarily set, based on the vehicle performance, the riding comfort, and the like. Vc is an upper limit value of the limit speed by road shape VlmtR. For example, Vc is set to the limit speed Vlmt of the merging lane corresponding to each estimation position L0 acquired by the information acquisition unit 51, and is usually set to the legal limit speed. Herein, min (A, B) is a function which outputs any smaller one of A and B.

$$\begin{matrix}[ Math . 2 ] & \\ {V}_{lmtR} ( {L}_{0} ) = min ( {V}_{c} , \sqrt{\frac{a {y}_{max}}{\vert ρ ( {L}_{0} ) \vert}} ) & ( 2 )\end{matrix}$$

The target speed reaching determination unit 52 may calculates a limit speed by road shape VlmtRj, considering a lateral jerk, which is a speed at which a lateral jerk jy of the ego vehicle becomes less than or equal to a maximum lateral jerk jymax, based on the road shape and the maximum lateral jerk jymax; and may calculate either smaller one of the limit speed by road shape VlmtR considering the lateral acceleration, and the limit speed by road shape VlmtRj considering the lateral jerk, as the final limit speed by road shape VlmtR. For example, as shown in the next equation, the target speed reaching determination unit 52 calculates the limit speed by road shape VlmtRj considering the lateral jerk, based on the curvature change rate dp and the maximum lateral jerk jymax. Herein, the curvature change rate dp may be acquired from the information acquisition unit 51, and may be calculated from the curvature p.

$$\begin{matrix}[ Math . 3 ] & \\ \begin{matrix}{V}_{lmtRj} ( {L}_{0} ) = min ( {V}_{c} , \sqrt[3]{\frac{{jy}_{max}}{\vert d ρ ( {L}_{0} ) \vert}} ) \\ {V}_{lmtR}^{′} ( {L}_{0} ) = min ( {V}_{lmtR} ( {L}_{0} ) , {V}_{lmtRj} ( {L}_{0} ) )\end{matrix} & ( 3 )\end{matrix}$$

### <Correction Processing of Limit Speed by Road Shape VlmtR>

In the present embodiment, the target speed reaching determination unit 52 corrects the limit speed by road shape VlmtR so that the lateral acceleration ay and the longitudinal acceleration ax of the ego vehicle when traveling at the limit speed by road shape VlmtR become within a limit range. According to this configuration, the limit speed by road shape VlmtR is corrected considering the limit range of the lateral acceleration ay and the longitudinal acceleration ax, and the estimation accuracy can be improved.

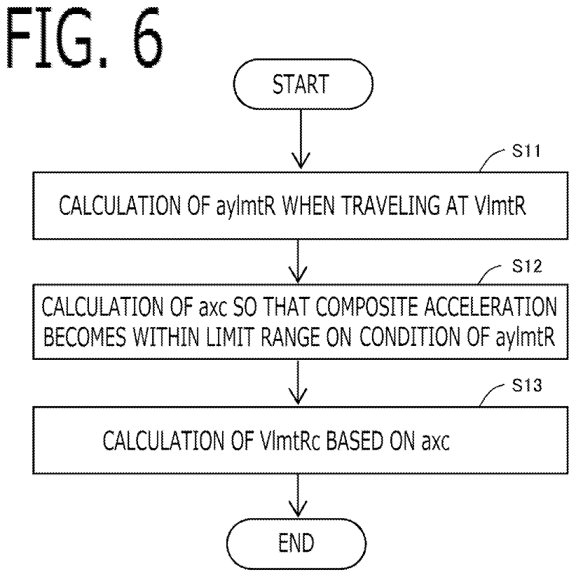

Hereinafter, using the flowchart of FIG. 6, a correction processing of the limit speed by road shape VlmtR will be explained. About each estimation position L0 of the merging lane in front of the ego vehicle, the processing of the flowchart of FIG. 6 is executed, and when the lateral acceleration ay and the longitudinal acceleration ax exceed the limit range, the limit speed by road shape VlmtR (L0) at each estimation position L0 is corrected. In a section where acceleration is performed, the estimation position L0 is increased to the front in increments of the interval dL. In a section where deceleration is performed, the estimation position L0 is decreased to the back in decrements of the interval dL.

In the step S11, the target speed reaching determination unit 52 calculates a lateral acceleration aylmtR when traveling at the limit speed by road shape VlmtR before the correction processing (hereinafter, referred to as a lateral acceleration aylmtR at the limit speed before the correction processing). For example, the target speed reaching determination unit 52 calculates the lateral acceleration aylmtR at the limit speed before the correction processing (L0) at the present estimation position L0, based on the limit speed by road shape VlmtR (L0) at the present estimation position L0, and the curvature ρ (L0) of the road at the present estimation position L0.

[Math. 4]

ay_{lmtR}(L₀)=ρ(L₀)V_{lmtR}²(L₀) (4)

In the step S12, on a condition using the lateral acceleration aylmtR (L0) at the limit speed before the correction processing at the present estimation position L0, the target speed reaching determination unit 52 calculates a longitudinal acceleration axc (L0) (hereinafter, referred to as a longitudinal acceleration axc after the correction processing) at the present estimation position L0 such that a composite acceleration acmp of the ego vehicle becomes within the limit range which is set based on the maximum lateral acceleration aymax and the maximum longitudinal acceleration axmax. The maximum lateral acceleration aymax and the maximum longitudinal acceleration axmax are preliminarily set considering the vehicle performance, the riding comfort, and the like. As shown in the next equation, at the time of acceleration, the maximum longitudinal acceleration axmax is set to a maximum longitudinal acceleration on the acceleration side axmaxA which is set to a positive value. At the time of deceleration, the maximum longitudinal acceleration axmax is set to a maximum longitudinal acceleration on the deceleration side axmaxD which is set to a negative value. The absolute value of the maximum longitudinal acceleration on the acceleration side axmaxA and the absolute value of maximum longitudinal acceleration on the deceleration side axmaxD may be set to different values, or may be set to the same values.

[Math. 5]

When accelerating:axₘₐₓ=ax_{maxA}>0

When decelerating:axₘₐₓ=ax_{maxD}<0 (5)

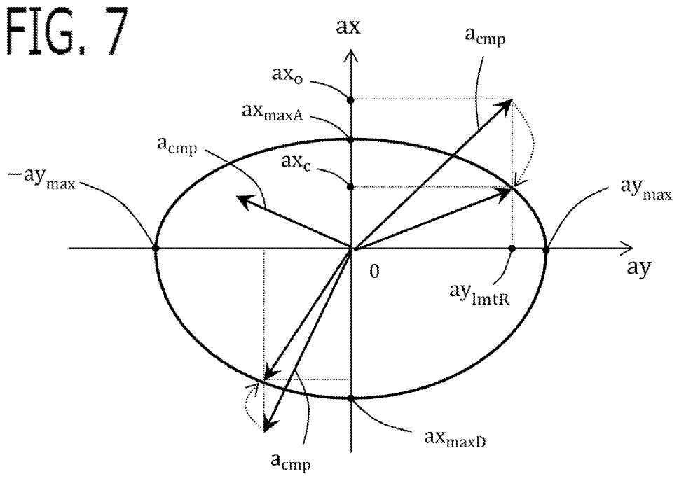

In the present embodiment, as shown in FIG. 7 and the next equation, in a coordinate system consisting of the axis of the lateral acceleration ay and the axis of the longitudinal acceleration ax, the limit range is set to an elliptical limit range which passes through the maximum lateral acceleration aymax and the maximum longitudinal acceleration axmax. The lateral acceleration in the right direction ay is defined as a positive value, and the lateral acceleration in the left direction ay is defined as a negative value.

$$\begin{matrix}[ Math . 6 ] & \\ {( \frac{ax}{a {x}_{max}} )}^{2} + {( \frac{a y}{a {y}_{max}} )}^{2} = 1 & ( 6 )\end{matrix}$$

The target speed reaching determination unit 52 calculates the longitudinal acceleration axo (L0) before the correction processing corresponding to the limit speed by road shape VlmtR (L0) before the correction processing at the present estimation position L0. As shown in the next equation, the target speed reaching determination unit 52 calculates the longitudinal acceleration axo (L0) before the correction processing by a differential operation based on a time change amount of the limit speed by road shape VlmtR (L0) before the correction processing at the present estimation position L0. Herein, VlmtR (L0−dL) is the limit speed by road shape VlmtR before the correction processing at the previous estimation position (L0−dL) which is positioned backward from the present estimation position L0 by an interval dL. ΔT is a time interval corresponding to the interval dL between the previous estimation position (L0−dL) and the present estimation position L0. In this example, ΔT is calculated by dividing the interval dL by the limit speed by road shape VlmtR (L0−dL) at the previous estimation position (L0−dL).

$$\begin{matrix}[ Math . 7 ] & \\ \begin{matrix}{ax}_{o} ( {L}_{0} ) = \frac{{dV}_{lmtR} ( {L}_{0} )}{dt} = \frac{{V}_{lmtR} ( {L}_{0} ) - {V}_{lmtR} ( {L}_{0} - d L )}{Δ T} \\ Δ T = \frac{d L}{{V}_{lmtR} ( {L}_{0} - d L )}\end{matrix} & ( 7 )\end{matrix}$$

On a condition using the lateral acceleration aylmtR (L0) at the limit speed at the present estimation position L0, the target speed reaching determination unit 52 calculates the longitudinal acceleration axc (L0) after the correction processing at the present estimation position L0 where the composite acceleration acmp of the ego vehicle becomes the elliptical limit range of the equation (6). Specifically, as shown in FIG. 7 and the next equation, when the composite acceleration acmp of the lateral acceleration aylmtR (L0) at the limit speed before the correction processing and the longitudinal acceleration axo (L0) before the correction processing exceeds the limit range, the target speed reaching determination unit 52 calculates the longitudinal acceleration axc (L0) after the correction processing by correcting the longitudinal acceleration axo (L0) before the correction processing so that the composite acceleration acmp becomes within the limit range. When the composite acceleration acmp does not exceed the limit range, the target speed reaching determination unit 52 calculates the longitudinal acceleration axo (L0) before the correction processing as the longitudinal acceleration axc (L0) after the correction processing as it is.

$$\begin{matrix}[ Math . 8 ] & \\ \begin{matrix}\begin{matrix}1 ) When \vert {ax}_{o} ( {L}_{0} ) \vert > \vert {ax}_{max} \sqrt{1 - {( \frac{{ay}_{lmtR} ( {L}_{0} )}{{ay}_{max}} )}^{2}} \vert ( When exceeding limit range ) , \\ {ax}_{c} ( {L}_{0} ) = {ax}_{max} \sqrt{1 - {( \frac{{ay}_{lmtR} ( {L}_{0} )}{{ay}_{max}} )}^{2}}\end{matrix} \\ \begin{matrix}2 ) When \vert {ax}_{o} ( {L}_{0} ) \vert \leq \vert {ax}_{max} \sqrt{1 - {( \frac{{ay}_{lmtR} ( {L}_{0} )}{{ay}_{max}} )}^{2}} \vert ( When not exceeding limit range ) , \\ {ax}_{c} ( {L}_{0} ) = {ax}_{0} ( {L}_{0} )\end{matrix}\end{matrix} & ( 8 )\end{matrix}$$

In the step S13, the target speed reaching determination unit 52 calculates the limit speed by road shape VlmtRc (L0) after the correction processing at the present estimation position L0, based on the longitudinal acceleration axc (L0) after the correction processing at the present estimation position L0.

In an acceleration section where the limit speed VlmtR before the correction processing is accelerated, and a constant speed section where there is no deceleration section ahead, as shown in the next equation, the target speed reaching determination unit 52 calculates a speed at the present estimation position (L0) when accelerating at the longitudinal acceleration axc (L0) after the correction processing at the present estimation position (L0), from the limit speed by road shape VlmtRc (L0−dL) after the correction processing at the estimation position (L0−dL) positioned backward from the present estimation position (L0) by the interval dL, as the limit speed by road shape VlmtRc (L0) after the correction processing at the present estimation position (L0). The estimation position L0 is moved ahead in increments of the interval dL, and the calculation of the equation (9) is executed repeatedly. The limit speed VlmtRc after the correction processing is upper-limited by the limit speed VlmtR before the correction processing so as not to exceed the limit speed VlmtR before the correction processing. The limit speed VlmtRc after the correction processing at the start position of the acceleration section is set to the limit speed VlmtR before the correction processing.

[Math. 9]

In an acceleration section and a constant speed section where there is no deceleration section ahead,

V_{lmtRc}(L₀)=min(V_{lmtR}(L₀),\sqrt{V_{lmtRc}(L₀−dL)²+2·ax_{c}(L₀)·dL}) (9)

On the other hand, in a deceleration section where the limit speed VlmtR before the correction processing is decelerated, and a constant speed section in back of the deceleration section, as shown in the next equation, the target speed reaching determination unit 52 calculates a speed at the present estimation position (L0) such that a speed at a position positioned ahead from the present estimation position (L0) by the interval dL becomes the limit speed by road shape VlmtRc (L0+dL) after the correction processing at the estimation position (L0+dL) positioned ahead by the interval dL when decelerating at the longitudinal acceleration axc (L0) after the correction processing at the present estimation position (L0) from the present estimation position (L0), as the limit speed by road shape VlmtRc (L0) after the correction processing at the present estimation position (L0). The estimation position L0 is moved backward in increments of the interval dL, and the calculation of the equation (10) is executed repeatedly. The limit speed VlmtRc after the correction processing is upper-limited by the limit speed VlmtR before the correction processing so as not to exceed the limit speed VlmtR before the correction processing. The limit speed VlmtRc after the correction processing at the end position of the deceleration section is set to the limit speed VlmtR before the correction processing.

[Math. 10]

In a deceleration section and a constant speed section in back thereof,

V_{lmtRc}(L₀)=min(V_{lmtR}(L₀),\sqrt{V_{lmtRc}(L₀+dL)²−2·ax_{c}(L₀)·dL}) (10)

### <Prediction of Estimated Speed Vpre>

Then, the target speed reaching determination unit 52 estimates the estimated speed Vpre of the ego vehicle on the merging lane so that the speed of the ego vehicle becomes less than or equal to the limit speed by road shape VlmtR (in this example, the limit speed by road shape VlmtRc after the correction processing).

In the present embodiment, as shown in the next equation, the target speed reaching determination unit 52 calculates a speed obtained by upper-limiting an estimated speed Vpre0 (L0) of the ego vehicle at each estimation position L0 when accelerating at a preliminarily set acceleration axmg for merging, by the limit speed by road shape VlmtR (in this example, the limit speed VlmtRc after the correction processing), as the estimated speed Vpre of the ego vehicle. The acceleration axmg for merging may be changed according to a feature of the merging lane and the main lane (for example, a speed difference between the merging lane and the ego lane, a length of the merging lane). Alternatively, the acceleration axmg for merging may be set to the same value as the maximum longitudinal acceleration on the acceleration side axmaxA. The estimation position L0 is moved ahead from the current position (L0=0) in increments of the interval dL, and the calculation of the equation (11) is executed repeatedly. The estimated speed Vpre (0) at the current position (L0=0) is set to the current speed.

[Math. 11]

Vₚᵣₑ₀(L₀)=\sqrt{Vₚᵣₑ(L₀−dL)²+2·ax_{mg}(L₀)·dL}

Vₚᵣₑ(L₀)=min(V_{lmtRc}(L₀),Vₚᵣₑ₀(L₀)) (11)

The limit speed by road shape VlmtRc after the correction processing may be calculated as the estimated speed Vpre. In this case, since there is a case where a deviation between the estimated speed Vpre at the current position and the current speed is large, the estimated speed Vpre at the current position is set to the current speed, the estimated speed Vpre which reaches the limit speed VlmtRc after the correction processing from the current speed at a predetermined acceleration may be calculated.

The longitudinal slope of the merging lane may be used for the calculation of the estimated speed Vpre. For example, an increase or decrease amount of speed according to the longitudinal slope (for example, 4 km/h at 2% slope, 6 km/h at 4% slope) is added or subtracted from the estimated speed Vpre.

### <Determination of Target Speed Reaching Propriety>

The target speed reaching determination unit 52 determines that the estimated speed Vpre of the ego vehicle reaches the target speed Vobj, when the estimated speed Vpre of the ego vehicle exceeds a target speed Vobj between the merging start possible position Lmgst and the end of the merging lane Lmgend; and determines that the estimated speed Vpre of the ego vehicle does not reach the target speed Vobj, when not exceeding.

### <The Example of Estimation Processing of Estimated Speed Vpre>

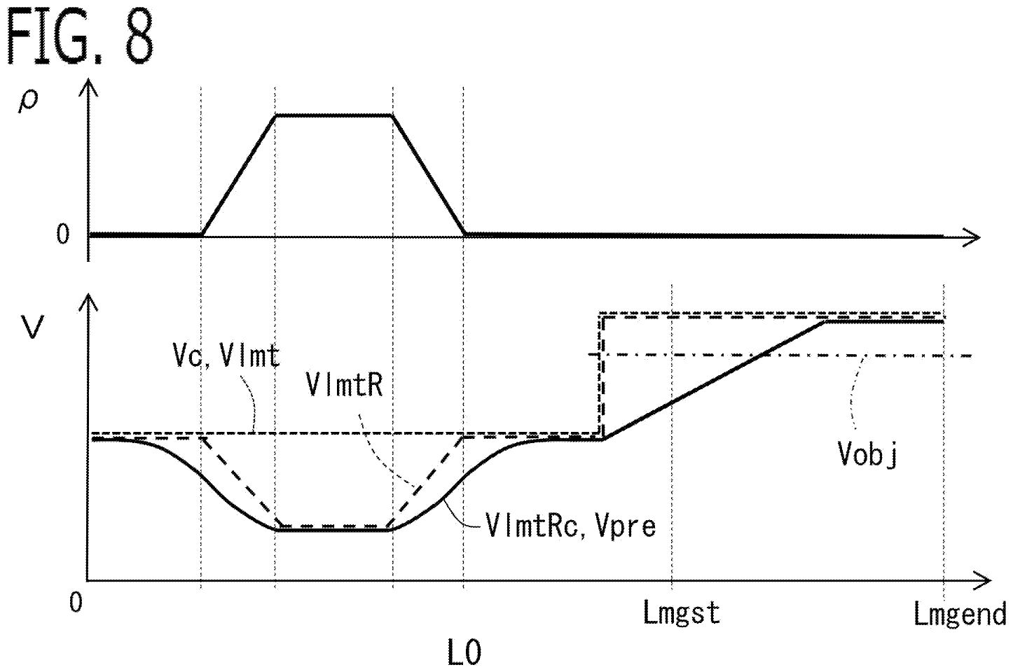

The estimation processing of the estimated speed Vpre will be explained using FIG. 8. Currently, the ego vehicle reaches near the entrance of the merging lane. The curve section exists in a connecting section of the merging lane before the merging start possible position, and the absolute value of the curvature ρ is increasing from 0. The limit speed Vc of the connecting section of the merging lane is set comparatively low, and the limit speed Vc of the accelerable section of the merging lane is set comparatively high. When the absolute value of the curvature ρ is 0, the limit speed by road shape VlmtR is upper-limited by the limit speed Vc, and coincides with the limit speed Vc. According to the increase amount of the absolute value of the curvature p, the limit speed by road shape VlmtR is decreasing from the limit speed Vc.

In the vicinity of the deceleration section and the acceleration section of the limit speed by road shape VlmtR, the limit speed by road shape VlmtRc after the correction processing is decreased and corrected from the limit speed by road shape VlmtR so that the lateral acceleration and the longitudinal acceleration of the ego vehicle become within the limit range. As explained using the equation (10), in the deceleration section of the limit speed VlmtR, the limit speed VlmtRc after the correction processing at the end position of the deceleration section is set to the limit speed VlmtR. And, the limit speed VlmtRc after the correction processing is calculated in order backward from the end position of the deceleration section, and is decreased and corrected from the limit speed VlmtR. As explained using the equation (9), in the acceleration section of the limit speed VlmtR, the limit speed VlmtRc after the correction processing at the start position of the acceleration section is set to the limit speed VlmtR. And, the limit speed VlmtRc after the correction processing is calculated in order forward from the start position of the acceleration section, and is decreased and corrected from the limit speed VlmtR.

In the accelerable section of the merging lane, the limit speed Vc increases and the limit speed by road shape VlmtR is increasing. However, the limit speed by road shape VlmtRc after the correction processing is gradually increasing from the start position of the accelerable section so that the lateral acceleration and the longitudinal acceleration of the ego vehicle become within the limit range.

In the example of FIG. 8, the acceleration axmg for merging is set to the same value as the maximum longitudinal acceleration on the acceleration side axmaxA, and the estimated speed Vpre coincides with the limit speed by road shape VlmtRc after the correction processing.

Since the estimated speed Vpre exceeds the target speed Vobj, it is determined that the estimated speed Vpre of the ego vehicle reaches the target speed Vobj between the merging start possible position Lmgst and the end of the merging lane Lmgend.

### 1-1-3. Emergency Stop Propriety Determination Unit 53

In the step S04 of FIG. 3, the emergency stop propriety determination unit 53 determines whether or not the ego vehicle can stop emergently on the merging lane, based on whether or not a distance Dmg from the merging start possible position Lmgst where a start of the merging into the main lane becomes possible on the merging lane to the end of the merging lane Lmgend (hereinafter, referred to as a merging possible distance Dmg) is greater than or equal to an emergency stop necessary distance Dstp required for stopping the ego vehicle emergently.

The emergency stop propriety determination unit 53 calculates the emergency stop necessary distance Dstp, based on the estimated speed Vpre, and a negative acceleration astp which is set at an execution time of an emergency stop driving (hereinafter, referred to as negative acceleration astp for emergency stop). According to this configuration, based on the estimated speed Vpre and the negative acceleration astp for emergency stop, a traveling distance during a deceleration period from starting the emergency stop driving until stopping can be calculated with good accuracy. Since the estimated speed Vpre is used, the calculation accuracy can be improved.

In the present embodiment, as described later, when the determination result of the merging propriety is impossible, the vehicle control unit 55 inquires of the driver about a propriety of a transfer of driving authority of the ego vehicle from the vehicle control unit to the driver. When a transferable inquiry result is obtained until an inquiry waiting time Twt elapsed after a start of inquiry, the vehicle control unit 55 transfers the driving authority to the driver.

Then, the emergency stop propriety determination unit 53 calculates the emergency stop necessary distance Dstp, based on the estimated speed Vpre, the inquiry waiting time Twt, and a negative acceleration astp (hereinafter, referred to as a negative acceleration astp for emergency stop) which is set at the execution time of the emergency stop driving. According to this configuration, a traveling distance during the inquiry waiting time Twt required for the transfer of the driving authority executed when the merging is impossible is also considered, and the emergency stop necessary distance Dstp can be calculated with good accuracy.

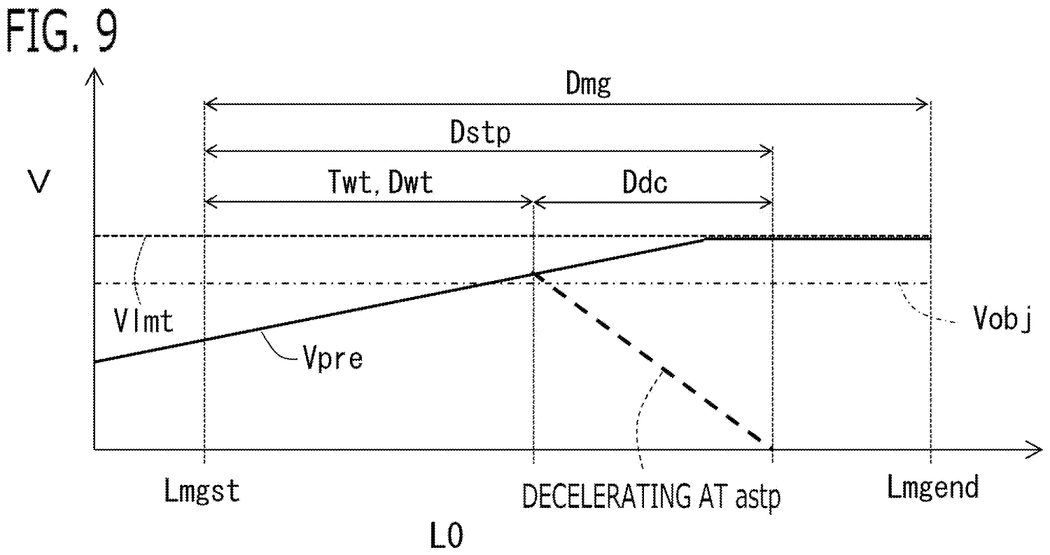

As shown in FIG. 9, the emergency stop propriety determination unit 53 calculates, as the emergency stop necessary distance Dstp, a total distance of a traveling distance of waiting period Dwt when moving during the inquiry waiting time Twt at the estimated speed Vpre from the merging start possible position Lmgst, and a traveling distance of deceleration period Ddc until the ego vehicle stops by decelerating at the negative acceleration astp for emergency stop from a position of the traveling distance of waiting period Dwt. According to this configuration, based on the traveling distance of waiting period Dwt and the traveling distance of deceleration period Ddc, the emergency stop necessary distance Dstp can be calculated with good accuracy.

The emergency stop propriety determination unit 53 integrates the estimated speed Vpre (L0) at each prediction position L0 after the merging start possible position Lmgst, during the inquiry waiting time Twt, and calculates the traveling distance of waiting period Dwt. For example, the emergency stop propriety determination unit 53 calculates a distance D0 when moving during very short time Δt at the estimated speed Vpre (Lmgst) at the merging start possible position Lmgst; calculates a distance D1 when moving during very short time Δt at the estimated speed Vpre (Lmgst+D0) at the estimation position Lmgst+D0; and calculates a distance D2 when moving during very short time Δt at the estimated speed Vpre (Lmgst+D0+D1) at the estimation position Lmgst+D0+D1. The emergency stop propriety determination unit 53 repeats this integration processing of the traveling distance during very short time Δt Twt/Δt times, and calculates an integration value of the traveling distances D0, D1 . . . , as the traveling distance of waiting period Dwt.

The emergency stop propriety determination unit 53 calculates a traveling distance when decelerating at the negative acceleration astp for emergency stop from the estimated speed Vpre at the start position of the emergency stop driving, as the traveling distance of deceleration period Ddc. In the present embodiment, the start position of the emergency stop driving is set to a total value of the merging start possible position Lmgst and the traveling distance of waiting period Dwt. For example, the emergency stop propriety determination unit 53 calculates the traveling distance of deceleration period Ddc using the next equation.

$$\begin{matrix}[ Math . 12 ] & \\ {D}_{d c} = \frac{1}{2} \frac{1}{\vert {a}_{stp} \vert} {{V}_{pre} ( {L}_{mgst} + {D}_{wt} )}^{2} & ( 12 )\end{matrix}$$

The emergency stop propriety determination unit 53 determines that the ego vehicle can stop emergently on the merging lane, when the emergency stop necessary distance Dstp (=Dwt+Ddc) is less than the merging possible distance Dmg from the merging start possible position Lmgst to the end of the merging lane Lmgend; and determines that the ego vehicle cannot stop emergently on the merging lane, when the emergency stop necessary distance Dstp is greater than or equal to the merging possible distance Dmg.

### 1-1-4. Merging Propriety Determination Unit 54

In the step S05 of FIG. 3, the merging propriety determination unit 54 determines whether or not the ego vehicle can merge into the main lane from the merging lane, based on a determination result of a target speed reaching propriety by the target speed reaching determination unit 52, and a determination result of an emergency stop propriety by the emergency stop propriety determination unit 53. According to this configuration, although it is better to sufficiently accelerate until the merging start possible position in order to be able to reach the target speed, it is better not to accelerate too much until the merging start possible position in order to be able to stop emergently. That is, being able to reach the target speed and being able to stop emergently are in a trade-off relation. Accordingly, by determining whether or not the merging vehicle can merge based on the determination result of the target speed reaching propriety, and the determination result of the emergency stop propriety, it can be determined considering both determination results which are in the trade-off relation, and the safety at the time of merging can be improved.

In the present embodiment, the merging propriety determination unit 54 ends the determination of merging propriety before the ego vehicle arrives at the merging start possible position Lmgst.

In the present embodiment, when the determination result of the target speed reaching propriety is possible and the determination result of the emergency stop propriety is possible until the ego vehicle arrives at a determination position Ljd which is set at a position before the merging start possible position Lmgst, the merging propriety determination unit 54 determines that the determination result of the merging propriety is impossible. On the other hand, when the determination result of the target speed reaching propriety became impossible or the determination result of the emergency stop propriety became impossible until the ego vehicle arrived at the determination position Ljd, the merging propriety determination unit 54 determines that the determination result of the merging propriety is impossible. As mentioned above, although it is better to sufficiently accelerate until the merging start possible position in order to be able to reach the target speed, it is better not to accelerate too much until the merging start possible position in order to be able to stop emergently. That is, being able to reach the target speed and being able to stop emergently are in a trade-off relation. Accordingly, a case where the target speed reaching is possible and the emergency stop is possible is a state where safety is high from both viewpoints. In this case, by determining that the determination result of the merging propriety is possible, safety can be improved more.

For example, the determination position Ljd is set to a position before the merging start possible position Lmgst by a threshold distance. The threshold distance is set to a value obtained by multiplying a predetermined time (for example, 4 seconds) to the estimated speed Vpre (Lmgst) at the merging start possible position Lmgst. By determining the merging propriety at the position before the merging start possible position Lmgst, when the merging is impossible, the driving authority can be transferred to the driver with a margin.

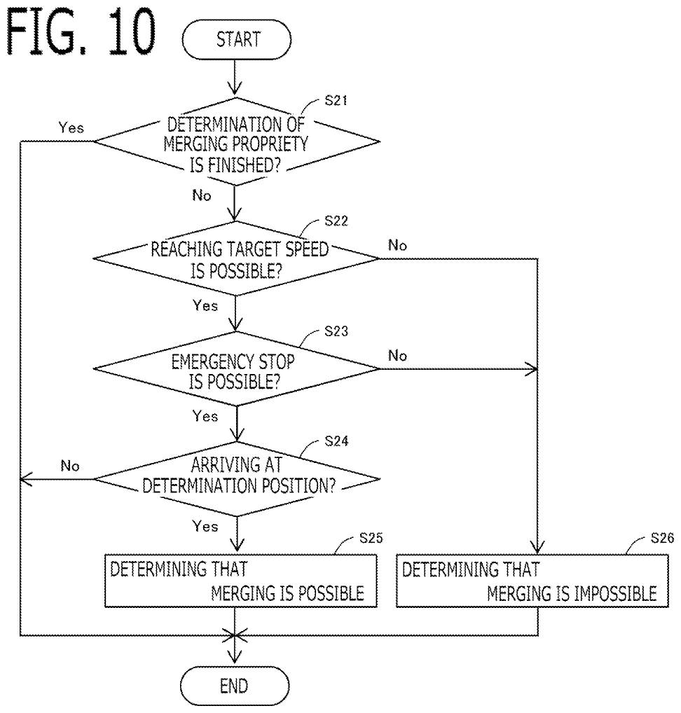

For example, the processing of the merging propriety determination unit 54 according to the present embodiment is configured as shown in the flowchart of FIG. 10. In the step S21, the merging propriety determination unit 54 determines whether or not it was already determined that the determination result of the merging propriety is possible or impossible in the step S25 or the step S26. When not determining that it is possible or impossible, it advances to the step S22, and when determining that it is possible or impossible, the processing is ended.

In the step S22, the merging propriety determination unit 54 determines whether or not the determination result of the target speed reaching propriety by the target speed reaching determination unit 52 is possible. When it is possible, it advances to the step S23, and when it is impossible, it advances to the step S26. In the step S23, the merging propriety determination unit 54 determines whether or not the determination result of the emergency stop propriety by the emergency stop propriety determination unit 53 is possible. When it is possible, it advances to the step S24, and when it is impossible, it advances to the step S26.

In the step S24, the merging propriety determination unit 54 determines whether or not the ego vehicle arrives at the determination position Ljd which is set to a position before the merging start possible position Lmgst. When it arrives, it advances to the step S25, and when it does not arrive, the processing is ended.

In the step S25, the merging propriety determination unit 54 determines that the determination result of the merging propriety is impossible. On the other hand, in the step S26, the merging propriety determination unit 54 determines that the determination result of the merging propriety is impossible.

### 1-1-5. Vehicle Control Unit 55

In the step S06 of FIG. 3, the vehicle control unit 55 controls a driving of the ego vehicle, based on a determination result of a merging propriety by the merging propriety determination unit 54.

### <When the Merging is Possible>

When the determination result of the merging propriety is possible, the vehicle control unit 55 performs a vehicle control for merging possible, for merging into the main lane. In the present embodiment, the vehicle control unit 55 performs one or both of a speed adjusting control and a steering control of the ego vehicle for merging into the main lane, as the vehicle control for merging possible.

When performing the speed adjusting control, the vehicle control unit 55 accelerates the ego vehicle at the acceleration axmg for merging, in order to coincide the speed of the ego vehicle with the limit speed of the main lane. In the present embodiment, the vehicle control unit 55 sets the estimated speed Vpre of the ego vehicle or the limit speed by road shape VlmtRc after the correction processing, as the target speed, changes the output of the power machine 8 and changes the braking force of the electric brake apparatus 9 so that the speed of the ego vehicle follows the target speed. When changing lanes from the merging lane to the main lane, the vehicle control unit 55 performs the acceleration or deceleration of the ego vehicle so as to merge smoothly, based on movement information of a vehicle which is traveling on the main lane.

When performing the steering control, the vehicle control unit 55 changes the steering angle of the electric steering apparatus 7 so that the ego vehicle travels within the merging lane. When changing lanes from the merging lane to the main lane, the vehicle control unit 55 changes the steering angle of the electric steering apparatus 7 so that the ego vehicle performs a lane change. The vehicle control unit 55 performs the vehicle control considering the peripheral vehicle, the obstacle, and the like.

The vehicle control unit 55 may sets a target traveling trajectory, and may control the vehicle so that the ego vehicle follows the target traveling trajectory. The target traveling trajectory is a time series traveling plan of the position of the ego vehicle, the traveling direction of the ego vehicle, the speed of the ego vehicle, and the like at each future time point.

The vehicle control unit 55 calculates the target output of the power machine 8, the target braking force of the electric brake apparatus 9, the target steering angle of the electric steering apparatus 7, and the like, and transmits them to the drive control apparatus 36. The drive control apparatus 36 consists of the power controller, the brake controller, the automatic steering controller, the light controller, and the like. The power controller controls the output of the power machines 8, such as the internal combustion engine and the motor, according to the target output. The brake controller controls the brake operation of the electric brake apparatus 9 according to the target braking force. The automatic steering controller controls the electric steering apparatus 7, according to the target steering angle. The light controller controls the direction indicator according to the operation command of the direction indicator.

### <When the Merging is Impossible>

When the determination result of the merging propriety is impossible, the vehicle control unit 55 inquires of the driver about a propriety of a transfer of driving authority of the ego vehicle from the vehicle control unit to the driver. When the transferable inquiry result is obtained, the vehicle control unit 55 transfers the driving authority to the driver. In the present embodiment, when the transferable inquiry result is obtained until the inquiry waiting time Twt elapsed after the start of inquiry, the vehicle control unit 55 transfers the driving authority to the driver. When the transferable inquiry result is not obtained even when the inquiry waiting time Twt elapsed after the start of inquiry, the vehicle control unit 55 performs the emergency stop driving of the ego vehicle.

When the driving authority is transferred to the driver and the manual driving by the driver is performed, the vehicle control unit 55 calculates the target output of the power machine 8, the target braking force of the electric brake apparatus 9, the target steering angle of the electric steering apparatus 7, and the like according to a command of the accelerator pedal operation, the brake pedal operation, the handle operation, and the like by the driver, and transmits them to the drive control apparatus 36.

When the emergency stop driving is performed, the vehicle control unit 55 decelerates the ego vehicle so that the ego vehicle can stop before the end of the merging lane. The vehicle control unit 55 changes the braking force of the electric brake apparatus 9, and changes the output of the power machine 8 so that the ego vehicle decelerates at the negative acceleration astp for emergency stop. The vehicle control unit 55 may change the steering angle of the electric steering apparatus 7 so as not to deviate from the merging lane. When the ego vehicle cannot stop before the end of the merging lane by the negative acceleration astp for emergency stop, the vehicle control unit 55 increases the absolute value of the negative acceleration astp for emergency stop so as to be able to stop.

### <Informing to Driver>

The vehicle control unit 55 informs the driver of a content of the driving control of the ego vehicle which is based on the determination result of the merging propriety. The vehicle control unit 55 informs the driver of the content of driving control via the human interface apparatus 37, such as the loudspeaker and the display screen. Safeness can be given to the driver by informing.

### <Flowchart of Vehicle Control Unit 55>

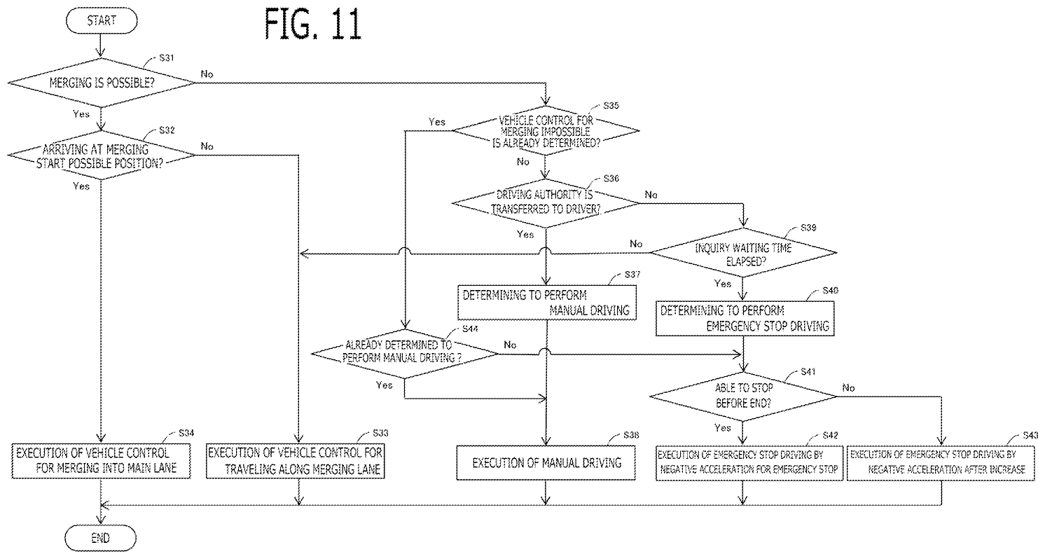

For example, the processing of the vehicle control unit 55 according to the present embodiment is configured as shown in the flowchart of FIG. 11. In the step S31, the vehicle control unit 55 determines whether or not the determination result of the merging propriety by the merging propriety determination unit 54 is possible. When it is possible, it advances to the step S32, and when it is impossible, it advances to the step S35.

In the step S32, the vehicle control unit 55 determines whether or not the ego vehicle arrived at the merging start possible position Lmgst. When it does not arrive, it advances to the step S33, and when it arrived, it advances to the step S34. In the step S33, the vehicle control unit 55 performs one or both of the speed adjusting control and the steering control of the ego vehicle for making the ego vehicle travel along the merging lane. The speed adjusting control also includes a control of accelerating the vehicle for merging. On the other hand, in the step S34, the vehicle control unit 55 performs one or both of the speed adjusting control and the steering control of the ego vehicle for making the ego vehicle merge into the main lane from the merging lane.

On the other hand, in the step S35, the vehicle control unit 55 determines whether or not the vehicle control which is performed when the merging is impossible was already determined to the manual driving or the emergency stop driving by the driver. When not determining, it advances to the step S36, and when determining, it advances to the step S44.

In the step S36, when the inquiry of the transfer of the driving authority is not started yet, the vehicle control unit 55 starts the inquiry of the transfer of the driving authority. When the transferable inquiry result is obtained, it advances to the step S37, and when the transferable inquiry result is not obtained, it advances to the step S39.

In the step S37, the vehicle control unit 55 determines to perform the manual driving by the driver. Then, in the step S38, the vehicle control unit 55 performs the manual driving. As mentioned above, the vehicle control unit 55 calculates the target output of the power machine 8, the target braking force of the electric brake apparatus 9, the target steering angle of the electric steering apparatus 7, and the like according to commands of the accelerator pedal operation, the brake pedal operation, the handle operation, and the like by the driver, and transmits them to the drive control apparatus 36.

On the other hand, in the step S39, the vehicle control unit 55 determines whether or not the inquiry waiting time Twt elapsed after the start of inquiry. When it elapsed, it advances to the step S40, and when it does not elapse, it advances to the step S33. In the step S39, the vehicle control unit 55 may determine whether or not the ego vehicle arrived at the merging start possible position Lmgst. When it arrived, it may advance to the step S40, and when it does not arrive, it may advance to the step S33. In the step S40, the vehicle control unit 55 determines to perform the emergency stop driving. When the driver performs an override during execution of the emergency stop driving, the vehicle control unit 55 may switch to the manual driving by the driver. When the driving authority is not transferred to the driver until the inquiry waiting time Twt elapsed after the start of inquiry (or until the ego vehicle arrives at the merging start possible position Lmgst), the vehicle control unit 55 may continue the inquiry of the transfer of the driving authority, without performing the emergency stop driving. Alternatively, when the automatic driving level is high (for example, when it is level 4 or more), the vehicle control unit 55 may determine to perform the emergency stop driving. And, when the automatic driving level is low (for example, when it is level 3 or less), the vehicle control unit 55 may continue the inquiry of the transfer of the driving authority, without performing the emergency stop driving.

Then, in the step S41, the vehicle control unit 55 determines whether or not the ego vehicle can stop before the end of the merging lane by the negative acceleration astp for emergency stop. When it can stop, it advances to the step S42, and when it cannot stop, it advances to the step S43. Using the next equation, the vehicle control unit 55 calculates a stopping distance Dstpnow until stopping, based on the negative acceleration astp for emergency stop and the current vehicle speed Vnow; determines that the ego vehicle cannot stop, when the stopping distance Dstpnow is larger than a remaining distance Drmn from the current position of the ego vehicle to the end of the merging lane; and determines that the ego vehicle can stop, when the stopping distance Dstpnow is less than or equal to the remaining distance Drmn.

$$\begin{matrix}[ Math . 13 ] & \\ {D}_{stpnow} = \frac{1}{2} \frac{1}{\vert {a}_{stp} \vert} {V}_{now}^{2} & ( 13 )\end{matrix}$$

In the step S42, the vehicle control unit 55 performs the emergency stop driving by the negative acceleration astp for emergency stop. Specifically, the vehicle control unit 55 changes the braking force of the electric brake apparatus 9, and changes the output of the power machine 8 so that the ego vehicle decelerates at the negative acceleration astp for emergency stop. The vehicle control unit 55 may change the steering angle of the electric steering apparatus 7 so as not to deviate from the merging lane.

In the step S43, the vehicle control unit 55 performs the emergency stop driving by the negative acceleration astpin after the increase. The absolute value of negative acceleration astpin after the increase is set to a value larger than the absolute value of the negative acceleration astp for emergency stop. For example, the negative acceleration astpin after the increase is set to a negative acceleration such that the ego vehicle can stop before the end of the merging lane. Using the next equation, the vehicle control unit 55 sets the negative acceleration astpin after the increase, based on the current vehicle speed Vnow and the remaining distance Drmn from the current position of the ego vehicle to the end of the merging lane.

$$\begin{matrix}[ Math . 14 ] & \\ {a}_{stpin} = - \frac{1}{2} \frac{{V}_{now}^{2}}{{D}_{rmn}} & ( 14 )\end{matrix}$$

In the step S44, the vehicle control unit 55 already determined that the vehicle control which is performed when the merging is impossible is the manual driving, it advances to the step S38. When the vehicle control unit 55 already determined that the vehicle control is the emergency stop driving, it advances to the step S41.

### 2. Embodiment 2

Next, the vehicle control apparatus 50 according to Embodiment 2 will be explained. The explanation for constituent parts the same as those in Embodiment 1 will be omitted. The basic configuration of the vehicle control apparatus 50 according to the present embodiment is the same as that of Embodiment 1. The content of the vehicle control when determining that the merging is impossible is different from Embodiment 1.

In the present embodiment, when the merging propriety determination unit 54 determines that the merging is possible, the vehicle control apparatus 50 performs the vehicle control for merging possible, for merging into the main lane. And, when the merging propriety determination unit 54 determines that the merging is impossible, the vehicle control apparatus 50 performs a vehicle control for merging impossible which is different from the vehicle control for merging possible.

In the present embodiment, the vehicle control apparatus 50 performs, as the vehicle control for merging impossible, a vehicle control whose support level is lower than the support level of the vehicle control for merging possible. The support level is a support degree of supporting the driving of the driver.

For example, when the vehicle control for merging possible is a hands-off control, the vehicle control for merging impossible is set to a hands-on control. The hands-off control is the steering control and the speed adjusting control which are performed in a state where the driver released the hand from the handle. The hands-on control is the steering control and the speed adjusting control which are performed in a state where the driver grasped the handle.

Alternatively, when the vehicle control for merging possible is the steering control and the speed adjusting control, the vehicle control for merging impossible is set to only the steering control or only the speed adjusting control.

According to this configuration, when determining that the merging is impossible, while dropping the support level, monitoring the driver in preparation for the merging, and urging an intervention of the driver, the vehicle control is not stopped completely. Accordingly, a driving load of the driver can be reduced.

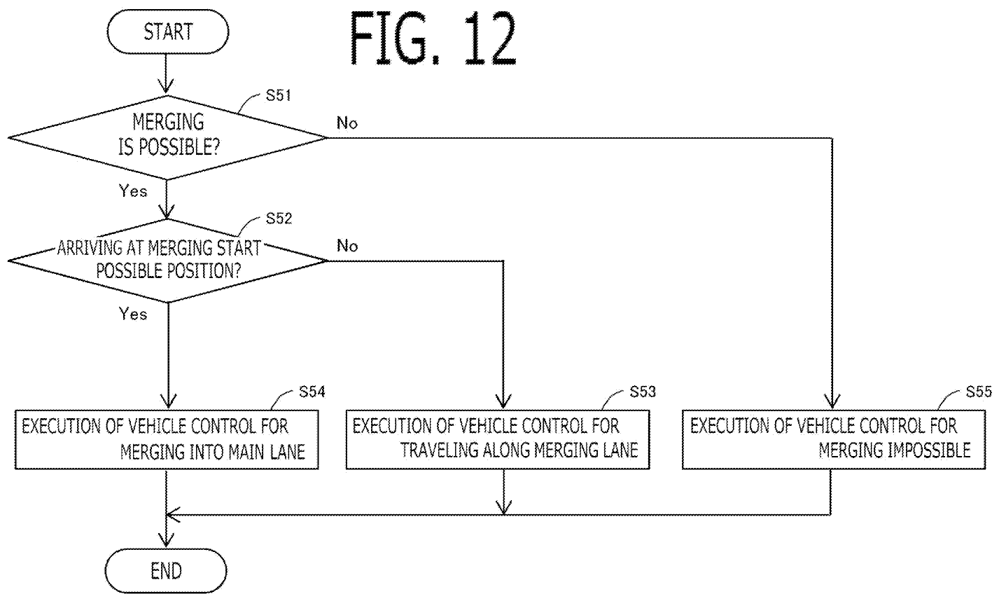

For example, the processing of the vehicle control unit 55 according to the present embodiment is configured as shown in the flowchart of FIG. 12. In the step S51, the vehicle control unit 55 determines whether or not the determination result of the merging propriety by the merging propriety determination unit 54 is possible. When it is possible, it advances to the step S52, and when it is impossible, it advances to the step S55.

In the step S52, the vehicle control unit 55 determines whether or not the ego vehicle arrived at the merging start possible position Lmgst. When it does not arrive, it advances to the step S53, and when it arrived, it advances to the step S54. In the step S53, as the vehicle control for merging possible, the vehicle control unit 55 performs one or both of the speed adjusting control and the steering control of the ego vehicle for making the ego vehicle travel along the merging lane. The speed adjusting control also includes a control of accelerating the vehicle for merging. On the other hand, in the step S54, as the vehicle control for merging possible, the vehicle control unit 55 performs one or both of the speed adjusting control and the steering control of the ego vehicle for making the ego vehicle merge into the main lane from the merging lane.

In the step S55, the vehicle control unit 55 performs the vehicle control for merging impossible which is different from the vehicle control for merging possible. In the present embodiment, the vehicle control apparatus 50 performs, as the vehicle control for merging impossible, a vehicle control whose support level is lower than the support level of the vehicle control for merging possible.

### 3. Embodiment 3

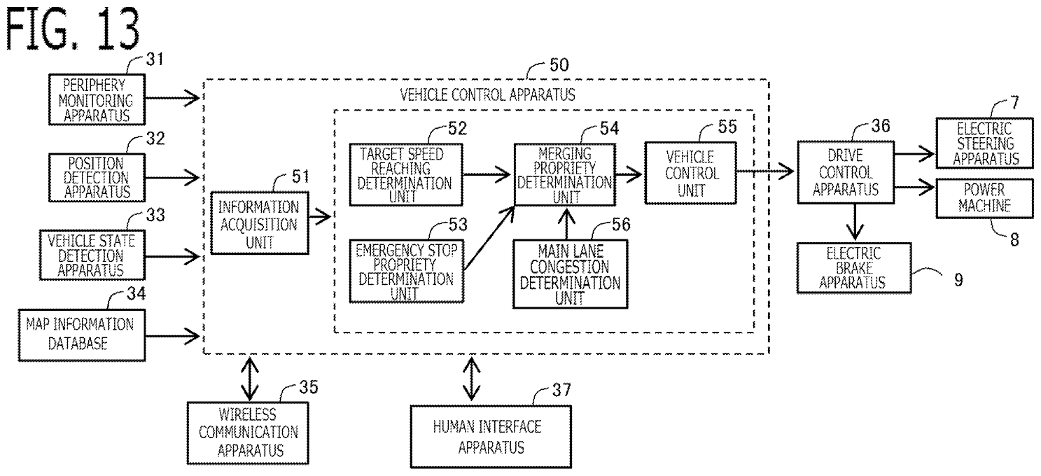

Next, the vehicle control apparatus 50 according to Embodiment 3 will be explained. The explanation for constituent parts the same as those in Embodiment 1 will be omitted. The basic configuration of the vehicle control apparatus 50 according to the present embodiment is the same as that of Embodiment 1. Embodiment 3 is different from Embodiment 1 in that a main lane congestion determination unit 56 is further provided, and the merging propriety determination unit 54 uses a determination result of a presence or absence of congestion of the main lane. FIG. 13 shows the block diagram of the vehicle control apparatus 50 according to the present embodiment.

In the present embodiment, the main lane congestion determination unit 56 determines a presence or absence of congestion of the main lane, based on information of a vehicle which is traveling on the main lane.

As explained in Embodiment 1, the information acquisition unit 51 acquires the information on the peripheral vehicle using the detection information of the periphery monitoring apparatus 31, by communication from the outside of the ego vehicle, the information on the peripheral vehicle is acquired from the peripheral vehicle and the roadside machine, or the server to which these information was uploaded. The main lane congestion determination unit 56 determines a vehicle which is traveling on the main lane, based on the information on the peripheral vehicle acquired by the information acquisition unit 51; and determines a presence or absence of congestion of the main lane, based on the information on the vehicles on the main lane.

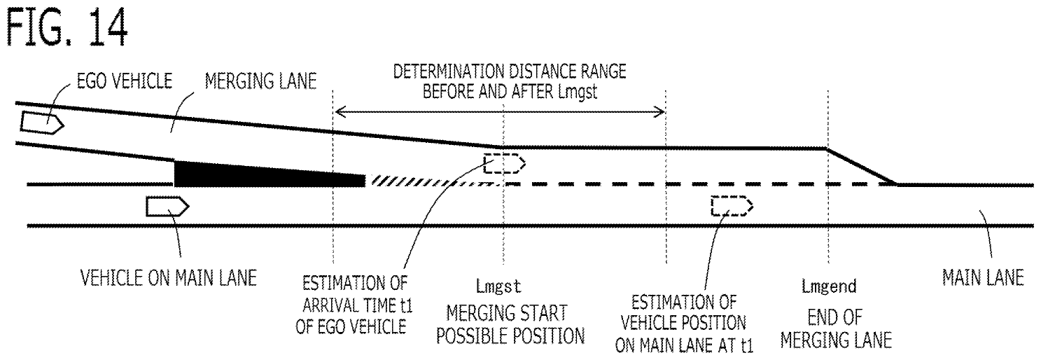

As shown in FIG. 14, the main lane congestion determination unit 56 estimates an arrival time t1 when the ego vehicle arrives at the merging start possible position Lmgst, based on the estimated speed Vpre; and estimates a position of each vehicle on the main lane at the arrival time t1, based on the movement information on the vehicles on the main lane. For example, the main lane congestion determination unit 56 estimates the position of each vehicle at the arrival time t1 when each vehicle on the main lane performs a constant speed movement at the current speed on the current traveling lane. Then, the main lane congestion determination unit 56 determines whether or not each vehicle on the main lane is positioned within a determination distance range which is set before and after the merging start possible position Lmgst, at the arrival time t1. When the number of vehicles positioned within the determination distance range is greater than or equal to a determination number (for example, one), the main lane congestion determination unit 56 determines that the main lane is congested. When the number of vehicles is less than the determination number, the main lane congestion determination unit 56 determines that the main lane is not congested. The determination distance and the determination number may be changed according to the limit speed of the main lane, the speed difference between the merging lane and the main lane, and the like.

The merging propriety determination unit 54 determines the merging propriety further based on the determination result of the presence or absence of congestion by the main lane congestion determination unit 56. According to this configuration, also in consideration of the determination result of the presence or absence of congestion of the main lane, the merging propriety can be determined more appropriately.

In the present embodiment, even when determining that the ego vehicle cannot merge into the main lane from the merging lane based on the determination result of the target speed reaching propriety by the target speed reaching determination unit 52 and the determination result of the emergency stop propriety by the emergency stop propriety determination unit 53, when the determination result of the presence or absence of congestion by the main lane congestion determination unit 56 is no congestion, the merging propriety determination unit 54 determines that the ego vehicle can merge into the main lane from the merging lane.

According to this configuration, when the main lane is not congested, even if the ego vehicle cannot reach the target speed, the ego vehicle can merge into the main lane, without contacting with the vehicle on the main lane which is traveling according to the limit speed of the main lane. Accordingly, it can be appropriately determined that the ego vehicle can merge into the main lane. Even if the ego vehicle enters into the main lane, without being able to stop before the end of the merging lane. When the main lane is not congested, the ego vehicle can merge into the main lane, without contacting with the vehicle on the main lane. Accordingly, it can be appropriately determined that the ego vehicle can merge into the main lane.

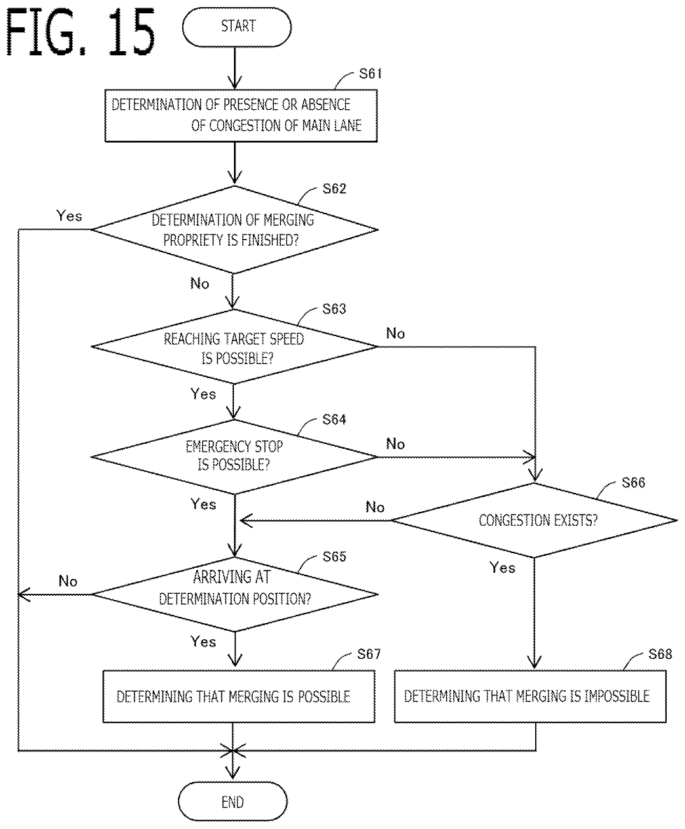

For example, the processing of the main lane congestion determination unit 56 and the merging propriety determination unit 54 according to the present embodiment is configured as shown in the flowchart of FIG. 15.

In the step S61, as mentioned above, the main lane congestion determination unit 56 determines a presence or absence of congestion of the main lane, based on vehicle information which is traveling on the main lane.

In the step S62, the merging propriety determination unit 54 determines whether or not it was already determined that the determination result of the merging propriety is possible or impossible in the step S67 or the step S68, when not determining that it is possible or impossible, it advances to the step S63, and when determining that it is possible or impossible, the processing is ended.

In the step S63, the merging propriety determination unit 54 determines whether or not the determination result of the target speed reaching propriety by the target speed reaching determination unit 52 is possible. When it is possible, it advances to the step S64, and when it is impossible, it advances to the step S66. In the step S64, the merging propriety determination unit 54 determines whether or not the determination result of the emergency stop propriety by the emergency stop propriety determination unit 53 is possible. When it is possible, it advances to the step S65, and when it is impossible, it advances to the step S66.

In the step S67, as mentioned above, when the determination result of the presence or absence of congestion by the main lane congestion determination unit 56 is the absence of congestion, the merging propriety determination unit 54 advances to the step S65, and when the determination result is the presence of congestion, it advances to the step S68.

In the step S65, the merging propriety determination unit 54 determines whether or not the ego vehicle arrives at the determination position Ljd which is set to a position before the merging start possible position Lmgst. When it arrives, it advances to the step S67, and when it does not arrive, the processing is ended.

In the step S67, the merging propriety determination unit 54 determines that the determination result of the merging propriety is impossible. On the other hand, in the step S68, the merging propriety determination unit 54 determines that the determination result of the merging propriety is impossible.

### 4. Embodiment 4

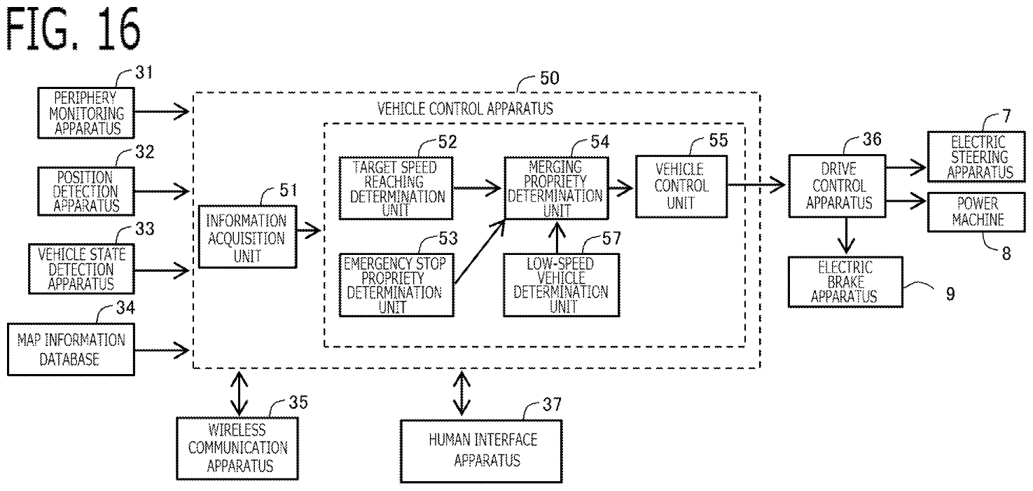

Next, the vehicle control apparatus 50 according to Embodiment 4 will be explained. The explanation for constituent parts the same as those in Embodiment 1 will be omitted. The basic configuration of the vehicle control apparatus 50 according to the present embodiment is the same as that of Embodiment 1. Embodiment 4 is different from Embodiment 1 in that a low-speed vehicle determination unit 57 is further provided, and the merging propriety determination unit 54 uses a determination result of a presence or absence of a low-speed preceding vehicle. FIG. 16 shows the block diagram of the vehicle control apparatus 50 according to the present embodiment.

In the present embodiment, the low-speed vehicle determination unit 57 determines whether or not a low-speed preceding vehicle which is a preceding vehicle slower than the estimated speed of the ego vehicle exists in front of the ego vehicle.

As explained in Embodiment 1, the information acquisition unit 51 acquires the information on the peripheral vehicle using the detection information of the periphery monitoring apparatus 31, by communication from the outside of the ego vehicle, the information on the peripheral vehicle is acquired from the peripheral vehicle and the roadside machine, or the server to which these information was uploaded. The low-speed vehicle determination unit 57 determines a preceding vehicle which is traveling in front of the ego vehicle on the merging lane, based on the information on the peripheral vehicle acquired by the information acquisition unit 51, and acquires movement information of the preceding vehicle.

For example, when the preceding vehicle exists, and a speed difference obtained by subtracting the current speed of the preceding vehicle from the estimated speed Vpre of the ego vehicle which is estimated at the current position of the preceding vehicle is greater than or equal to a determination speed difference, the low-speed vehicle determination unit 57 determines that the low-speed preceding vehicle exists. Otherwise, the low-speed vehicle determination unit 57 determines that the low-speed preceding vehicle does not exist. When a distance between the ego vehicle and the preceding vehicle is greater than or equal to a determination distance, the low-speed vehicle determination unit 57 determines that the low-speed preceding vehicle does not exist.

The merging propriety determination unit 54 determines the merging propriety further based on the determination result of the presence or absence of the low-speed preceding vehicle by the low-speed vehicle determination unit 57. According to this configuration, also in consideration of the determination result of the presence or absence of the low-speed preceding vehicle, the merging propriety can be determined more appropriately.

In the present embodiment, even when determining that the ego vehicle can merge into the main lane from the merging lane based on the determination result of the target speed reaching propriety by the target speed reaching determination unit 52 and the determination result of the emergency stop propriety by the emergency stop propriety determination unit 53, when the determination result of the presence or absence of the low-speed preceding vehicle by the low-speed vehicle determination unit 57 is the presence of the low-speed preceding vehicle, the merging propriety determination unit 54 determines that the ego vehicle cannot merge into the main lane from the merging lane.

According to this configuration, even when determining that the ego vehicle can merge into the main lane from the merging lane based on the determination result of the target speed reaching propriety, and the determination result of the emergency stop propriety, when the low-speed preceding vehicle exists, acceleration of the ego vehicle is limited by the low-speed preceding vehicle, and the ego vehicle may be unable to reach the target speed. Accordingly, it can be appropriately determined that that ego vehicle cannot merge into the main lane.

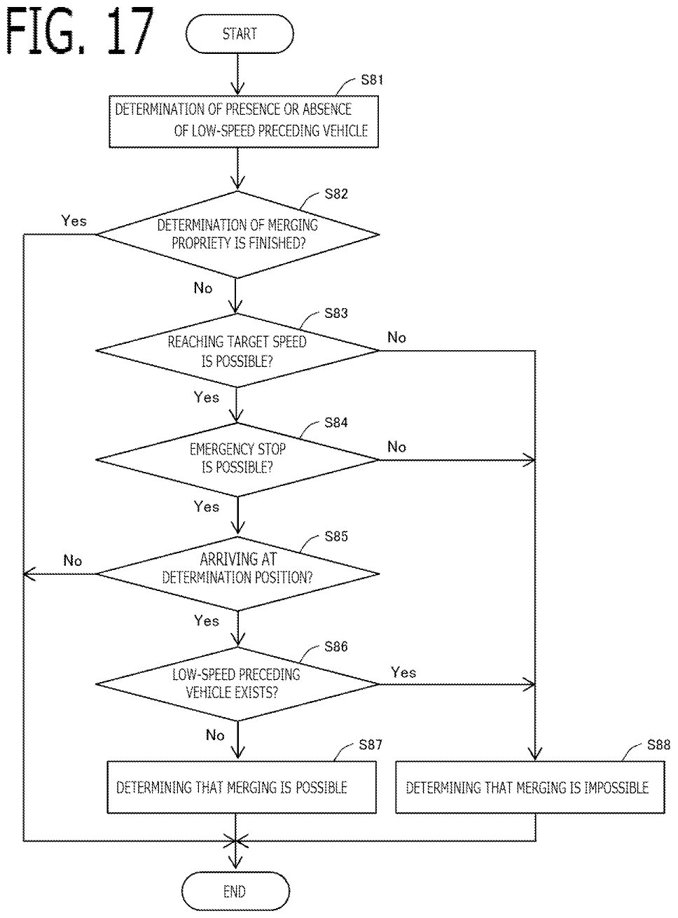

For example, the processing of the low-speed vehicle determination unit 57 and the merging propriety determination unit 54 according to the present embodiment is configured as shown in the flowchart of FIG. 17.

In the step S81, as mentioned above, the low-speed vehicle determination unit 57 determines whether or not a low-speed preceding vehicle which is a preceding vehicle slower than the estimated speed of the ego vehicle exists in front of the ego vehicle.

In the step S82, the merging propriety determination unit 54 determines whether or not it was already determined that the determination result of the merging propriety is possible or impossible in the step S87 or the step S88. When not determining that it is possible or impossible, it advances to the step S83, and when determining that it is possible or impossible, the processing is ended.

In the step S83, the merging propriety determination unit 54 determines whether or not the determination result of the target speed reaching propriety by the target speed reaching determination unit 52 is possible. When it is possible, it advances to the step S84, and when it is impossible, it advances to the step S88. In the step S84, the merging propriety determination unit 54 determines whether or not the determination result of the emergency stop propriety by the emergency stop propriety determination unit 53 is possible. When it is possible, it advances to the step S85, and when it is impossible, it advances to the step S88.

In the step S85, the merging propriety determination unit 54 determines whether or not the ego vehicle arrives at the determination position Ljd which is set to a position before the merging start possible position Lmgst. When it arrives, it advances to the step S86, and when it does not arrive, the processing is ended.

In the step S86, when the determination result of the presence or absence of the low-speed preceding vehicle by the low-speed vehicle determination unit 57 is the presence of the low-speed preceding vehicle, the merging propriety determination unit 54 advances to the step S88, and when the determination result is the absence of the low-speed preceding vehicle, it advances to the step S87.

In the step S87, the merging propriety determination unit 54 determines that the determination result of the merging propriety is impossible. On the other hand, in the step S88, the merging propriety determination unit 54 determines that the determination result of the merging propriety is impossible.

### 5. Embodiment 5

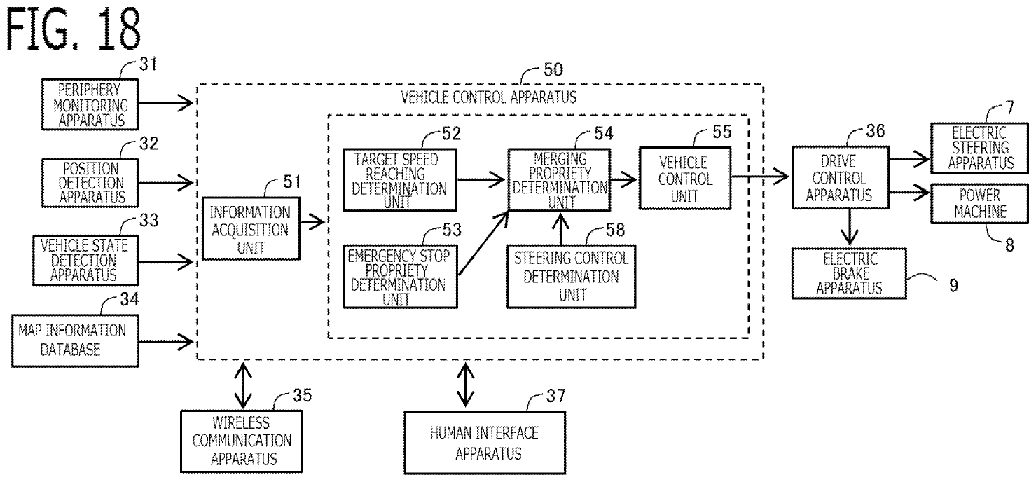

Next, the vehicle control apparatus 50 according to Embodiment 5 will be explained. The explanation for constituent parts the same as those in Embodiment 1 will be omitted. The basic configuration of the vehicle control apparatus 50 according to the present embodiment is the same as that of Embodiment 1. Embodiment 5 is different from. Embodiment 1 in that a steering control determination unit 58 is further provided, and the merging propriety determination unit 54 uses a determination result of a propriety of the steering control for merging. FIG. 18 shows the block diagram of the vehicle control apparatus 50 according to the present embodiment.

In the present embodiment, the steering control determination unit 58 determines a propriety of a steering control for merging, based on an effectiveness of acquired lane information of the merging lane.

As explained in Embodiment 1, the information acquisition unit 51 acquires the lane information of the merging lane, based on the detection information of the lane marking, such as the white line and the road shoulder, acquired from the periphery monitoring apparatus 31. The information acquisition unit 51 acquires the lane information of the merging lane from the map information database 34, based on the position information of the ego vehicle acquired from the position detection apparatus 32. The information acquisition unit 51 acquires the lane information of the merging lane from the peripheral vehicle and the roadside machine, or the server to which these information was uploaded, by communication from the outside of the ego vehicle.

Due to a blur, an afternoon sun, a backlight, a sharp curve, and the like, the lane information of the merging lane cannot be acquired, or the reliability of the acquired lane information is low. When the lane marking of the merging lane cannot be acquired, or when the reliability of the acquired lane marking of the merging lane is low, the steering control determination unit 58 determines that the lane information of the merging lane is not effective. For example, the reliability of the detection information by the camera and the radar is used. When information of a plurality of lane markings is obtained from a plurality of apparatuses, an average value of the reliabilities of the information of the plurality of lane marking may be used.

When determining that the lane information of the merging lane is not effective, the steering control determination unit 58 determines that the steering control for merging cannot be performed, and when determining that the lane information of the merging lane is effective, the steering control determination unit 58 determines that the steering control for merging can be performed.

The steering control determination unit 58 may determine the propriety of the steering control for merging, based on the curvature radius of the merging lane acquired from the information acquisition unit 51. When the curvature radius of the merging lane is less than a curvature radius threshold value, the steering control determination unit 58 may determine that lane information of the merging lane is not effective, and may determine that the steering control for merging cannot be performed. The curvature radius threshold value is set to the minimum curvature radius which can be detected by the camera and the radar mounted on the ego vehicle, for example.

The merging propriety determination unit 54 determines the merging propriety further based on the determination result of the steering control propriety by the steering control determination unit 58. According to this configuration, also in consideration of the determination result of the steering control propriety based on the effectiveness of the lane information of the merging lane, the merging propriety can be determined more appropriately.

In the present embodiment, even when determining that the ego vehicle can merge into the main lane from the merging lane based on the determination result of the target speed reaching propriety by the target speed reaching determination unit 52 and the determination result of the emergency stop propriety by the emergency stop propriety determination unit 53, when the determination result of the steering control propriety by the steering control determination unit 58 is impossible for the steering control, the merging propriety determination unit 54 determines that the ego vehicle cannot merge into the main lane from the merging lane.

According to this configuration, even when determining that the ego vehicle can merge into the main lane from the merging lane based on the determination result of the target speed reaching propriety, and the determination result of the emergency stop propriety, when the steering control for merging is impossible, the ego vehicle may be unable to merge into the main lane by the steering control. Accordingly, it can be appropriately determined that that ego vehicle cannot merge into the main lane.

In the present embodiment, similarly to Embodiment 2, when the merging propriety determination unit 54 determines that the merging is possible, the vehicle control apparatus 50 performs the vehicle control for merging possible, for merging into the main lane. When the merging propriety determination unit 54 determines that the merging is possible, the vehicle control apparatus 50 performs a vehicle control for merging impossible which is different from the vehicle control for merging possible.

In the present embodiment, the vehicle control apparatus 50 performs, as the vehicle control for merging impossible, a vehicle control whose support level is lower than the support level of the vehicle control for merging possible. The support level is a support degree of supporting the driving of the driver.

For example, when the vehicle control for merging possible is a hands-off control, the vehicle control for merging impossible is set to a hands-on control. The hands-off control is the steering control and the speed adjusting control which are performed in a state where the driver released the hand from the handle. The hands-on control is the steering control and the speed adjusting control which are performed in a state where the driver grasped the handle.

Alternatively, when the vehicle control for merging possible is the steering control and the speed adjusting control, the vehicle control for merging impossible is set to only the steering control or only the speed adjusting control.

According to this configuration, when determining that the merging is impossible due to impossibility of the steering control and the like, while dropping the support level, monitoring the driver in preparation for the merging, and urging an intervention of the driver, the vehicle control is not stopped completely. Accordingly, a driving load of the driver can be reduced.

Alternatively, similarly to Embodiment 1, the vehicle control apparatus 50 may perform the inquiry of transfer of the driving authority and the emergency stop control, as the vehicle control for merging impossible.

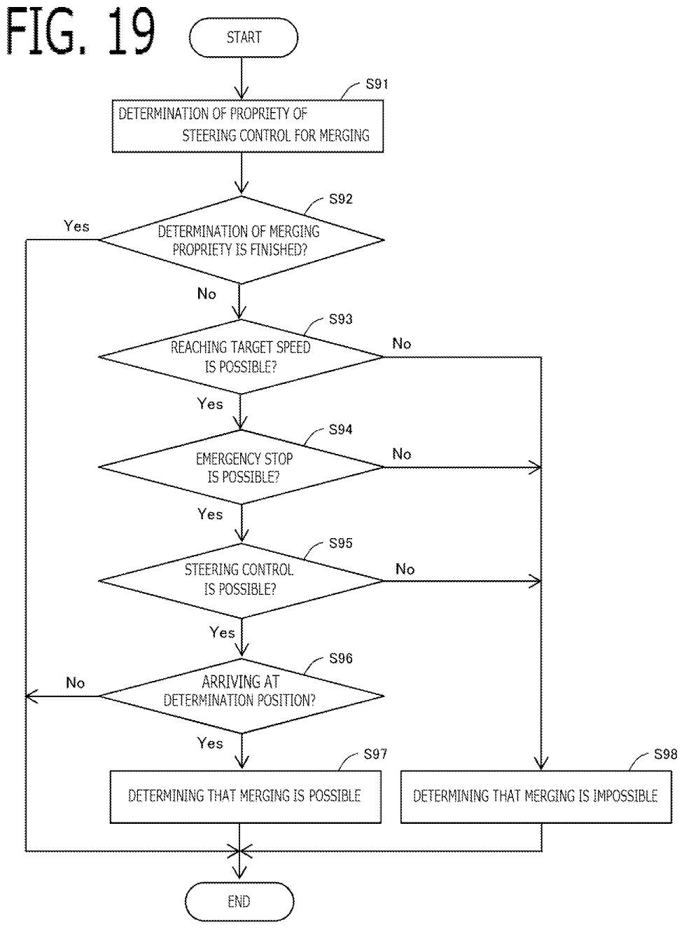

For example, the processing of the steering control determination unit 58 and the merging propriety determination unit 54 according to the present embodiment is configured as shown in the flowchart of FIG. 19.

In the step S91, as mentioned above, the steering control determination unit 58 determines a propriety of a steering control for merging, based on an effectiveness of acquired lane information of the merging lane.

In the step S92, the merging propriety determination unit 54 determines whether or not it was already determined that the determination result of the merging propriety is possible or impossible in the step S97 or the step S98. When not determining that it is possible or impossible, it advances to the step S93, and when determining that it is possible or impossible, the processing is ended.

In the step S93, the merging propriety determination unit 54 determines whether or not the determination result of the target speed reaching propriety by the target speed reaching determination unit 52 is possible. When it is possible, it advances to the step S94, and when it is impossible, it advances to the step S98. In the step S94, the merging propriety determination unit 54 determines whether or not the determination result of the emergency stop propriety by the emergency stop propriety determination unit 53 is possible. When it is possible, it advances to the step S95, and when it is impossible, it advances to the step S98.

In the step S95, when the determination result of the steering control propriety by the steering control determination unit 58 is possible for the steering control, the merging propriety determination unit 54 advances to the step S96, and when the determination result is impossible for the steering control, it advances to the step S98.

In the step S96, the merging propriety determination unit 54 determines whether or not the ego vehicle arrives at the determination position Ljd which is set to a position before the merging start possible position Lmgst. When it arrives, it advances to the step S97, and when it does not arrive, the processing is ended.

In the step S97, the merging propriety determination unit 54 determines that the determination result of the merging propriety is impossible. On the other hand, in the step S98, the merging propriety determination unit 54 determines that the determination result of the merging propriety is impossible.

### Other Embodiments

Embodiments 3, 4, and 5 may be combined arbitrarily. For example, Embodiments 3, 4, and 5 are combined, and the vehicle control apparatus 50 may be further provided with the main lane congestion determination unit 56, the low-speed vehicle determination unit 57, and the steering control determination unit 58. Then, the merging propriety determination unit 54 may determine the merging propriety, based on the determination result of the target speed reaching propriety by the target speed reaching determination unit 52, the determination result of the emergency stop propriety by the emergency stop propriety determination unit 53, the determination result of the presence or absence of congestion by the main lane congestion determination unit 56, the determination result of the presence or absence of the low-speed preceding vehicle by the low-speed vehicle determination unit 57, and the determination result of the steering control propriety by the steering control determination unit 58. The determination processings of the merging propriety explained in Embodiments 3, 4, and 5 are combined.

Alternatively, Embodiments 3 and 4 may be combined, and the vehicle control apparatus 50 may be further provided with the main lane congestion determination unit 56 and the low-speed vehicle determination unit 57. Then, the merging propriety determination unit 54 may determine the merging propriety, based on the determination result of the target speed reaching propriety by the target speed reaching determination unit 52, the determination result of the emergency stop propriety by the emergency stop propriety determination unit 53, the determination result of the presence or absence of congestion by the main lane congestion determination unit 56, and the determination result of the presence or absence of the low-speed preceding vehicle by the low-speed vehicle determination unit 57. The determination processings of the merging propriety explained in Embodiments 3 and 4 are combined.

Alternatively, Embodiments 4 and 5 may be combined, the vehicle control apparatus 50 may be further provided with the low-speed vehicle determination unit 57 and the steering control determination unit 58. Then, the merging propriety determination unit 54 may determine the merging propriety, based on the determination result of the target speed reaching propriety by the target speed reaching determination unit 52, the determination result of the emergency stop propriety by the emergency stop propriety determination unit 53, the determination result of the presence or absence of the low-speed preceding vehicle by the low-speed vehicle determination unit 57, and the determination result of the steering control propriety by the steering control determination unit 58. The determination processings of the merging propriety explained in Embodiments 4 and 5 are combined.

### Summary of Aspects of the Present Disclosure

Hereinafter, the aspects of the present disclosure is summarized as appendixes.

### APPENDIX 1

A vehicle control apparatus comprising:
a target speed reaching determination unit that estimates a speed of an ego vehicle on a merging lane, based on road information in front of the ego vehicle which travels on the merging lane which merges into a main lane, and determines whether or not the estimated speed of the ego vehicle reaches a target speed for merging into the main lane;
an emergency stop propriety determination unit that determines whether or not the ego vehicle can stop emergently on the merging lane, based on whether or not a distance from a merging start possible position where a start of the merging into the main lane becomes possible on the merging lane, to an end of the merging lane is greater than or equal to an emergency stop necessary distance required for stopping the ego vehicle emergently;
a merging propriety determination unit that determines whether or not the ego vehicle can merge into the main lane from the merging lane, based on a determination result of a target speed reaching propriety by the target speed reaching determination unit, and a determination result of an emergency stop propriety by the emergency stop propriety determination unit; and
a vehicle control unit that controls a driving of the ego vehicle, based on a determination result of a merging propriety by the merging propriety determination unit.

### APPENDIX 2

The vehicle control apparatus according to appendix 1,
wherein, when the determination result of the target speed reaching propriety is possible and the determination result of the emergency stop propriety is possible until the ego vehicle arrives at a determination position which is set at a position before the merging start possible position, the merging propriety determination unit determines that the determination result of the merging propriety is possible, and
when the determination result of the target speed reaching propriety became impossible or the determination result of the emergency stop propriety became impossible until the ego vehicle arrived at the determination position, the merging propriety determination unit determines that the determination result of the merging propriety is impossible.

### APPENDIX 3

The vehicle control apparatus according to appendix 1 or 2,
wherein the emergency stop propriety determination unit calculates the emergency stop necessary distance, based on the estimated speed and a negative acceleration which is set at an execution time of an emergency stop driving of stopping the ego vehicle emergently.

### APPENDIX 4

The vehicle control apparatus according to any one of appendixes 1 to 3,
when the determination result of the merging propriety is impossible, the vehicle control unit inquires of a driver about a propriety of a transfer of driving authority of the ego vehicle from the vehicle control unit to the driver,
when a transferable inquiry result is obtained until an inquiry waiting time elapsed after a start of inquiry, the vehicle control unit transfers the driving authority to the driver, and when the transferable inquiry result is not obtained even when the inquiry waiting time elapsed after the start of inquiry, the vehicle control unit executes an emergency stop driving of the ego vehicle,
wherein the emergency stop propriety determination unit calculates the emergency stop necessary distance, based on the estimated speed, the inquiry waiting time, and a negative acceleration which is set at an execution time of the emergency stop driving.

### APPENDIX 5

The vehicle control apparatus according to appendix 4,
wherein the emergency stop propriety determination unit calculates, as the emergency stop necessary distance, a total distance of a traveling distance of waiting period when moving during the inquiry waiting time at the estimated speed from the merging start possible position, and a traveling distance of deceleration period until the ego vehicle stops by decelerating at the negative acceleration from a position of the traveling distance of waiting period.

### APPENDIX 6

The vehicle control apparatus according to any one of appendixes 1 to 5,
wherein the target speed reaching determination unit sets the target speed, based on a limit speed of the main lane.

### APPENDIX 7

The vehicle control apparatus according to any one of appendixes 1 to 6,
wherein the target speed reaching determination unit estimates the estimated speed of the ego vehicle on the merging lane, based on a road shape of the merging lane, and a maximum lateral acceleration which is allowable for the ego vehicle.

### APPENDIX 8

The vehicle control apparatus according to appendix 7,
wherein the target speed reaching determination unit calculates a limit speed by road shape which is a speed at which a lateral acceleration of the ego vehicle becomes the less than or equal to the maximum lateral acceleration, based on a road shape of the merging lane and the maximum lateral acceleration; and
estimates the estimated speed of the ego vehicle on the merging lane so that the estimated speed of the ego vehicle becomes less than or equal to the limit speed by road shape.

### APPENDIX 9

The vehicle control apparatus according to appendix 8,
wherein the target speed reaching determination unit upper-limits the limit speed by road shape by a limit speed of the merging lane.

### APPENDIX 10

The vehicle control apparatus according to appendix 8 or 9,
wherein the target speed reaching determination unit corrects the limit speed by road shape so that a lateral acceleration and a longitudinal acceleration of the ego vehicle when traveling at the limit speed by road shape become within a limit range.

### APPENDIX 11

The vehicle control apparatus according to any one of appendixes 1 to 10, further comprising a main lane congestion determination unit that determines a presence or absence of congestion of the main lane, based on information of a vehicle which is traveling on the main lane,
wherein the merging propriety determination unit determines the merging propriety further based on a determination result of the presence or absence of congestion by the main lane congestion determination unit.

### APPENDIX 12

The vehicle control apparatus according to appendix 11,
wherein, even when determining that the ego vehicle cannot merge into the main lane from the merging lane based on the determination result of the target speed reaching propriety by the target speed reaching determination unit and the determination result of the emergency stop propriety by the emergency stop propriety determination unit, the merging propriety determination unit determines that the ego vehicle can merge into the main lane from the merging lane, when the determination result of the presence or absence of congestion by the main lane congestion determination unit is the absence of congestion.

### APPENDIX 13

The vehicle control apparatus according to any one of appendixes 1 to 12, further comprising a low-speed vehicle determination unit that determines whether or not a low-speed preceding vehicle which is a preceding vehicle slower than the estimated speed of the ego vehicle exists in front of the ego vehicle,
wherein the merging propriety determination unit determines the merging propriety further based on the determination result of a presence or absence of the low-speed preceding vehicle by the low-speed vehicle determination unit.

### APPENDIX 14

The vehicle control apparatus according to appendix 13,
wherein, even when determining that the ego vehicle can merge into the main lane from the merging lane based on the determination result of the target speed reaching propriety by the target speed reaching determination unit, and the determination result of the emergency stop propriety by the emergency stop propriety determination unit, the merging propriety determination unit determines that the ego vehicle cannot merge into the main lane from the merging lane, when the determination result of the presence or absence of the low-speed preceding vehicle by the low-speed vehicle determination unit is the presence of the low-speed preceding vehicle.

### APPENDIX 15

The vehicle control apparatus according to any one of appendixes 1 to 14, further comprising a steering control determination unit that determines a propriety of a steering control for merging, based on an effectiveness of acquired lane information of the merging lane,
wherein the merging propriety determination unit determines the merging propriety further based on a determination result of the propriety of the steering control by the steering control determination unit.

### APPENDIX 16

The vehicle control apparatus according to appendix 15,
wherein, even when determining that the ego vehicle can merge into the main lane from the merging lane based on the determination result of the target speed reaching propriety by the target speed reaching determination unit and the determination result of the emergency stop propriety by the emergency stop propriety determination unit, the merging propriety determination unit determines that the ego vehicle cannot merge into the main lane from the merging lane, when the determination result of the propriety of the steering control by the steering control determination unit is impossible.

### APPENDIX 17

The vehicle control apparatus according to any one of appendixes 1 to 16,
wherein, when the merging propriety determination unit determines that the merging is possible, the vehicle control unit performs a vehicle control for merging possible, for merging into the main lane, and
when the merging propriety determination unit determines that the merging is impossible, the vehicle control unit inquires of a driver about a propriety of a transfer of driving authority of the ego vehicle from the vehicle control unit to the driver, or executes a vehicle control for merging impossible which is different from the vehicle control for merging possible.

### APPENDIX 18

The vehicle control apparatus according to appendix 17,
wherein the vehicle control unit executes, as the vehicle control for merging impossible, a vehicle control whose support level is lower than a support level of the vehicle control for merging possible.

### APPENDIX 19

The vehicle control apparatus according to appendix 17,
wherein, when the merging propriety determination unit determines that the merging is impossible, the vehicle control unit inquires of a driver about a propriety of a transfer of driving authority of the ego vehicle from the vehicle control unit to the driver, and executes an emergency stop control of stopping the ego vehicle emergently, when an untransferable inquiry result is obtained.

### APPENDIX 20

The vehicle control apparatus according to any one of appendixes 1 to 19,
wherein the merging propriety determination unit ends determination of the merging propriety before the ego vehicle arrives at the merging start possible position, and
wherein the vehicle control unit informs a driver of a content of a driving control of the ego vehicle which is based on the determination result of the merging propriety.

Although the present disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations to one or more of the embodiments. It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

What is claimed is:

1. A vehicle control apparatus comprising at least one processor configured to implement:
a target speed reaching determiner that estimates a speed of an ego vehicle on a merging lane, based on road information in front of the ego vehicle which travels on the merging lane which merges into a main lane, and determines whether or not the estimated speed of the ego vehicle reaches a target speed for merging into the main lane;
an emergency stop propriety determiner that determines whether or not the ego vehicle can stop emergently on the merging lane, based on whether or not a distance from a merging start possible position where a start of the merging into the main lane becomes possible on the merging lane, to an end of the merging lane is greater than or equal to an emergency stop necessary distance required for stopping the ego vehicle emergently;
a merging propriety determiner that determines whether or not the ego vehicle can merge into the main lane from the merging lane, based on a determination result of a target speed reaching propriety by the target speed reaching determiner, and a determination result of an emergency stop propriety by the emergency stop propriety determiner; and
a vehicle controller that controls a driving of the ego vehicle, based on a determination result of a merging propriety by the merging propriety determiner.

2. The vehicle control apparatus according to claim 1,
wherein, when the determination result of the target speed reaching propriety is possible and the determination result of the emergency stop propriety is possible until the ego vehicle arrives at a determination position which is set at a position before the merging start possible position, the merging propriety determiner determines that the determination result of the merging propriety is possible, and
when the determination result of the target speed reaching propriety became impossible or the determination result of the emergency stop propriety became impossible until the ego vehicle arrived at the determination position, the merging propriety determiner determines that the determination result of the merging propriety is impossible.

3. The vehicle control apparatus according to claim 1,
wherein the emergency stop propriety determiner calculates the emergency stop necessary distance, based on the estimated speed and a negative acceleration which is set at an execution time of an emergency stop driving of stopping the ego vehicle emergently.

4. The vehicle control apparatus according to claim 1,
when the determination result of the merging propriety is impossible, the vehicle controller inquires of a driver about a propriety of a transfer of driving authority of the ego vehicle from the vehicle controller to the driver,
when a transferable inquiry result is obtained until an inquiry waiting time elapsed after a start of inquiry, the vehicle controller transfers the driving authority to the driver, and when the transferable inquiry result is not obtained even when the inquiry waiting time elapsed after the start of inquiry, the vehicle controller executes an emergency stop driving of the ego vehicle,
wherein the emergency stop propriety determiner calculates the emergency stop necessary distance, based on the estimated speed, the inquiry waiting time, and a negative acceleration which is set at an execution time of the emergency stop driving.

5. The vehicle control apparatus according to claim 4,
wherein the emergency stop propriety determiner calculates, as the emergency stop necessary distance, a total distance of a traveling distance of waiting period when moving during the inquiry waiting time at the estimated speed from the merging start possible position, and a traveling distance of deceleration period until the ego vehicle stops by decelerating at the negative acceleration from a position of the traveling distance of waiting period.

6. The vehicle control apparatus according to claim 1,
wherein the target speed reaching determiner sets the target speed, based on a limit speed of the main lane.

7. The vehicle control apparatus according to claim 1,
wherein the target speed reaching determiner estimates the estimated speed of the ego vehicle on the merging lane, based on a road shape of the merging lane, and a maximum lateral acceleration which is allowable for the ego vehicle.

8. The vehicle control apparatus according to claim 7,
wherein the target speed reaching determiner calculates a limit speed by road shape which is a speed at which a lateral acceleration of the ego vehicle becomes the less than or equal to the maximum lateral acceleration, based on a road shape of the merging lane and the maximum lateral acceleration; and
estimates the estimated speed of the ego vehicle on the merging lane so that the estimated speed of the ego vehicle becomes less than or equal to the limit speed by road shape.

9. The vehicle control apparatus according to claim 8,
wherein the target speed reaching determiner upper-limits the limit speed by road shape by a limit speed of the merging lane.

10. The vehicle control apparatus according to claim 8,
wherein the target speed reaching determiner corrects the limit speed by road shape so that a lateral acceleration and a longitudinal acceleration of the ego vehicle when traveling at the limit speed by road shape become within a limit range.

11. The vehicle control apparatus according to claim 1, further comprising a main lane congestion determiner that determines a presence or absence of congestion of the main lane, based on information of a vehicle which is traveling on the main lane,
wherein the merging propriety determiner determines the merging propriety further based on a determination result of the presence or absence of congestion by the main lane congestion determiner.

12. The vehicle control apparatus according to claim 11,
wherein, even when determining that the ego vehicle cannot merge into the main lane from the merging lane based on the determination result of the target speed reaching propriety by the target speed reaching determiner and the determination result of the emergency stop propriety by the emergency stop propriety determiner, the merging propriety determiner determines that the ego vehicle can merge into the main lane from the merging lane, when the determination result of the presence or absence of congestion by the main lane congestion determiner is the absence of congestion.

13. The vehicle control apparatus according to claim 1, further comprising a low-speed vehicle determiner that determines whether or not a low-speed preceding vehicle which is a preceding vehicle slower than the estimated speed of the ego vehicle exists in front of the ego vehicle,
wherein the merging propriety determiner determines the merging propriety further based on the determination result of a presence or absence of the low-speed preceding vehicle by the low-speed vehicle determiner.

14. The vehicle control apparatus according to claim 13,
wherein, even when determining that the ego vehicle can merge into the main lane from the merging lane based on the determination result of the target speed reaching propriety by the target speed reaching determiner, and the determination result of the emergency stop propriety by the emergency stop propriety determiner, the merging propriety determiner determines that the ego vehicle cannot merge into the main lane from the merging lane, when the determination result of the presence or absence of the low-speed preceding vehicle by the low-speed vehicle determiner is the presence of the low-speed preceding vehicle.

15. The vehicle control apparatus according to claim 1, further comprising a steering control determiner that determines a propriety of a steering control for merging, based on an effectiveness of acquired lane information of the merging lane,
wherein the merging propriety determiner determines the merging propriety further based on a determination result of the propriety of the steering control by the steering control determiner.

16. The vehicle control apparatus according to claim 15,
wherein, even when determining that the ego vehicle can merge into the main lane from the merging lane based on the determination result of the target speed reaching propriety by the target speed reaching determiner and the determination result of the emergency stop propriety by the emergency stop propriety determiner, the merging propriety determiner determines that the ego vehicle cannot merge into the main lane from the merging lane, when the determination result of the propriety of the steering control by the steering control determiner is impossible.

17. The vehicle control apparatus according to claim 1,
wherein, when the merging propriety determiner determines that the merging is possible, the vehicle controller performs a vehicle control for merging possible, for merging into the main lane, and
when the merging propriety determiner determines that the merging is impossible, the vehicle controller inquires of a driver about a propriety of a transfer of driving authority of the ego vehicle from the vehicle controller to the driver, or executes a vehicle control for merging impossible which is different from the vehicle control for merging possible.

18. The vehicle control apparatus according to claim 17,
wherein the vehicle controller executes, as the vehicle control for merging impossible, a vehicle control whose support level is lower than a support level of the vehicle control for merging possible.

19. The vehicle control apparatus according to claim 17,
wherein, when the merging propriety determiner determines that the merging is impossible, the vehicle controller inquires of a driver about a propriety of a transfer of driving authority of the ego vehicle from the vehicle controller to the driver, and executes an emergency stop control of stopping the ego vehicle emergently, when an untransferable inquiry result is obtained.

20. The vehicle control apparatus according to claim 1,
wherein the merging propriety determiner ends determination of the merging propriety before the ego vehicle arrives at the merging start possible position, and
wherein the vehicle controller informs a driver of a content of a driving control of the ego vehicle which is based on the determination result of the merging propriety.

21. A vehicle control method comprising:
a target speed reaching determination step of estimating a speed of an ego vehicle on a merging lane, based on road information in front of the ego vehicle which travels on the merging lane which merges into a main lane, and determining whether or not the estimated speed of the ego vehicle reaches a target speed for merging into the main lane;
an emergency stop propriety determination step of determining whether or not the ego vehicle can stop emergently on the merging lane, based on whether or not a distance from a merging start possible position where a start of the merging into the main lane becomes possible on the merging lane to an end of the merging lane is greater than or equal to an emergency stop necessary distance required for stopping the ego vehicle emergently;
a merging propriety determination step of determining whether or not the ego vehicle can merge into the main lane from the merging lane, based on a determination result of a target speed reaching propriety by the target speed reaching determination step, and a determination result of an emergency stop propriety by the emergency stop propriety determination step; and
a vehicle control step of controlling a driving of the ego vehicle, based on a determination result of a merging propriety by the merging propriety determination step.
